(19) United States
(12) Patent Application Publication
(10) Pub. No.: US 2005/0021319 A1
(43) Pub. Date: Jan. 27, 2005

(54) Methods, systems, and computer program products for modeling nonlinear systems

(76) Inventors: Peng Li, Pittsburgh, PA (US); Lawrence T. Pileggi, Pittsburgh, PA (US)

Correspondence Address: MYERS BIGEL SIBLEY & SAJOVEC, PO BOX 37428, RALEIGH, NC, 27627, US

(21) Appl. No.: 10/859,621

(22) Filed: Jun. 3, 2004

Related U.S. Application Data
(60) Provisional application No. 60/475,392, filed on Jun. 3, 2003.

(51) Int. Cl. G06F 17/10

(52) U.S. Cl. 703/2

(57) ABSTRACT

According to some embodiments of the present invention, a nonlinear system may be modeled by obtaining a transfer function for the nonlinear system and generating a Taylor series expansion of the transfer function. The Taylor series expansion includes a plurality of moments respectively corresponding to a plurality of coefficients of the Taylor series terms. At least one Krylov subspace is derived that matches at least one of the plurality of moments. The nonlinear system is modeled using the at least one Krylov subspace.

### RELATED APPLICATIONS

This application claims the benefit of and priority to U.S. Provisional Patent Application No. 60/475,392, filed Jun. 3, 2003, the disclosure of which is hereby incorporated herein by reference as if set forth in its entirety.

### FIELD OF THE INVENTION

The present invention relates to methods, systems, and computer program products for modeling circuits and/or systems, and, more particularly, to systems, methods, and computer products for modeling time-invariant and time-varying nonlinear circuits and/or systems.

### BACKGROUND OF THE INVENTION

Over the past decade a relatively large body of work on model order reduction of IC interconnects has emerged from the design automation community. One purpose of model reduction is to generate models that are orders of magnitude smaller than the original system while more accurately approximating the input/output relationships. Compared to the success of model order reduction for linear time invariant (LTI) RLC networks, the problem of reducing nonlinear systems has generally been less understood and explored. There are numerous applications, however, where abstracting transistor-level circuit details that include important weakly nonlinear effects into a compact macromodel may be important. For instance, in RF communication IC design there is a growing interest in extracting efficient circuit-level models that are capable of capturing system nonlinear distortion. While circuit blocks in these applications may exhibit weak nonlinearities, the design specification for linearity may be important and/or stringent. As depicted in FIG. 1, building compact blackbox type macromodels that accurately capture nonlinear input-output correspondence may facilitate efficient repetitive simulations of the circuit component being modeled, and may also enable entire-system verification and design trade-off analyses that may be impossible otherwise.

A piecewise-linear approximation based nonlinear systems reduction has been proposed where a set of linearizations about the state trajectory due to a training input is used to model a nonlinear system and each linearization is reduced using Krylov projection. While having the potential capability of handling large nonlinearities, such as may happen in a micromachined device, a potential limitation of this approach is its training input dependency.

A different model reduction direction has been taken based on the Volterra functional series that have been used as a means for analyzing weakly nonlinear systems. The application of the Volterra series may make it possible to solve the circuit response of a weakly nonlinear system from low orders to high orders via a recursive procedure, commonly referred to as nonlinear current method. Frequency domain characterizations based on Volterra kernels or nonlinear transfer functions describe input-independent system nonlinear properties in a manner analogous to the use of linear transfer functions for linear system properties. Projection based nonlinear model order reduction frameworks have been proposed for making automated nonlinear system reduction possible by extending the popular implicit moment-matching projection techniques used for interconnects. Some approaches use the Taylor series expansion of nonlinear state equations to represent a weakly nonlinear system. Then the nonlinear system model inherited from the recursive nonlinear current method is used to view a weakly nonlinear system as a set of interconnected linear networks. A benefit of this perspective is that it may allow the use of existing linear system reduction techniques to serve as blackbox tools to reduce each individual linear network for achieving the goal of overall nonlinear system reduction. Converting a nonlinear reduction problem to several linear reduction problems, however, may leave some issues unaddressed. For example, how does the quality of each linear reduction problem impact the accuracy of the overall nonlinear model? What is the best strategy in carrying out each linear reduction for achieving good nonlinear model accuracy?

Another approach that may provide a theoretical foundation uses the bilinear form of a nonlinear system and explicitly matches the moments of nonlinear transfer functions analogously to Padé approximations of LTI systems. The use of bilinear form may allow the nonlinear transfer function moments to be expressed in a structured fashion such that a projection based moment-matching reduction scheme can be derived. By converting a standard state-equation form to its bilinear counterpart, however, a relatively large number of additional state-variables may be introduced. For example, the bilinear form of a system including up to the third order nonlinear coefficient matrices has O(N₃) state variables, where N is the number of state variables in the original state equation form.

Under this framework of nonlinear model order reduction, the reduced model compactness facilitates effective model reduction. As the order of moment matching increases, the size of the reduced order model increases more rapidly. At the same time, as the size of the reduced model grows, it may become more costly to explicitly form the resulting high order system matrices of the reduced order model, thereby reducing the possible benefits of model reduction.

Background of Volterra Series

Time invariant Volterra series, which may be used for time-invariant systems will now be briefly discussed. For simplicity, consider a single-input multi-output system described by the following Modified Nodal Analysis (MNA) formulation:

$$f ( x ( r ) ) + \frac{ⅆ}{ⅆ i} q ( x ( t ) ) = bu ( t ) , y ( t ) = {d}^{T} x ( t ) \qquad ( 1 )$$

where x is the vector of node voltages and branch currents, u is the input to the system,f() and q() are nonlinear functions relating currents of nonlinear resistors and nonlinear charges/fluxes with x; y is the vector of the output; and b and d are the input and output matrices respectively. When the input is small, only weakly nonlinear behavior is excited in the system. Assume the system is perturbated about the DC bias condition due to a small-signal input. Using a Taylor series to expand f() and q() at the bias point x₀, and considering only small-signal quantities, we obtain

$$\frac{ⅆ}{ⅆ t} ( {C}_{1} x + {C}_{2} ( x ⊗ x ) + {C}_{3} ( x ⊗ x ⊗ x ) + … ) + {G}_{1} x + {G}_{2} ( x ⊗ x ) + {G}_{3} ( x ⊗ x ⊗ x ) + … = bu ( t ) \qquad ( 2 )$$

where \mathring{x} is the Kronecker product operator, x(t) and u(t) are the small signal response and the input to the system, and

$${G}_{1} = \frac{1}{i !} \frac{{\partial }^{t} f}{\partial {x}^{t}} {\vert}_{x = {x}_{1}} ∈ {R}^{n \times {n}^{1}} \cdot {C}_{t} = \frac{1}{i !} \frac{{\partial }^{t} q}{\partial {x}^{t}} {\vert}_{x = {x}_{0}} ∈ {R}^{n \times {R}^{t}}$$

are the ith order conductance and capacitance matrices, respectively.

A nonlinear system can be analyzed using Volterra functional series under weakly nonlinear conditions. In a Volterra series, the response x(t) can be expressed as a sum of responses at different orders

$$x ( t ) = {\sum }_{κ = 1}^{∞} {x}_{n} ( t ) , \qquad ( 3 )$$

where, xₙ is the n-th order response. The order of a response component specifies the cumulative number of multiplications of the input signal for generating the corresponding response. A converging Volterra series according to (3) may be truncated to a finite number of terms and each order of response may be solved recursively. The first order or linear response of the weakly nonlinear system in (2) may be obtained by retaining only first-order terms in (2).

$$\frac{ⅆ}{ⅆ t} ( {C}_{1} {x}_{1} ( t ) ) + {G}_{1} {x}_{1} ( t ) = bu ( t ) , \qquad ( 4 )$$

Equation (4) represents a linear time-invariant (LTI) system. Higher order responses may be computed by solving the linearized system with different inputs. The second and the third order responses are given by the following two equations using vector Kronecker products of x:

$$\begin{matrix}\frac{ⅆ}{ⅆ t} ( {C}_{1} {x}_{2} ) + {G}_{1} {x}_{2} = - \frac{ⅆ}{ⅆ t} ( {C}_{2} ( {x}_{1} ⊗ {x}_{1} ) ) - {G}_{2} ( {x}_{1} ⊗ {x}_{1} ) & ( 5 ) \\ \frac{ⅆ}{ⅆ t} ( {C}_{1} {x}_{3} ) + {G}_{1} {x}_{3} = - {G}_{3} ( {x}_{1} ⊗ {x}_{1} ⊗ {x}_{1} ) - 2 {G}_{2} ( \overline{{x}_{1} ⊗ {x}_{2}} ) - \frac{ⅆ}{ⅆ t} ( {C}_{3} ( {x}_{1} ⊗ {x}_{1} ⊗ {x}_{1} ) + 2 {C}_{2} ( \overline{{x}_{1} ⊗ {x}_{2}} ) ) . & ( 6 )\end{matrix}$$

In Equations (5) and (6), Gᵢ and Cᵢ are the ith order conductance and capacitance matrices respectively, and

$$( \overline{{x}_{1} ⊗ {x}_{2}} ) = \frac{1}{⊗} ( ( {x}_{1} ⊗ {x}_{2} ) + ( {x}_{2} ⊗ {x}_{1} ) ) .$$

Systems specified by Equations (4), (5), and (6) may be referred to as the linearized (first order), second order, and third order systems for Equation (2), respectively.

Alternatively, a weakly nonlinear system can be analyzed in the frequency domain, which is generally more suitable for a spectrum analysis. As an extension to the impulse response function of a LTI (linear time invariant) system, an nth order response can be related to a Volterra kernel of order nhₙ(τ₁, . . . , τ₂)

$${x}_{ɛ} ( t ) = {\int }_{- ∞}^{∞} … {\int }_{- ∞}^{∞} {h}_{g} ( {τ}_{1} , … , {τ}_{g} ) u ( t - {τ}_{1} ) … u ( t - {τ}_{g} ) ⅆ τ… ⅆ {τ}_{g} . \qquad ( 7 )$$

hₙ(τ₁, . . . , τₙ) can also be transformed into the frequency domain via a Laplace transform

$${H}_{n} ( {s}_{1} … {s}_{n} ) = {\int }_{- ∞}^{∞} … {\int }_{- ∞}^{∞} {h}_{n} ( {τ}_{1} , … , {τ}_{n} ) {ⅇ}^{- ( {s}_{1} {τ}_{1} + … + {s}_{n} {τ}_{n} )} ⅆ {τ}_{1} … ⅆ {τ}_{n} \qquad ( 8 )$$

and referred to as the nonlinear transfer function of order N. The nth order response, yₙ, can be related to the input as

$${x}_{n} ( t ) = {\int }_{- ∞}^{∞} … {\int }_{- ∞}^{∞} ( {H}_{n} ( {s}_{1} , … , {s}_{n} ) {\prod }_{t = 1}^{n} u ( {s}_{i} ) {ⅇ}^{{s}_{1} t} ) ⅆ {s}_{1} … ⅆ {s}_{n} . \qquad ( 9 )$$

Based on Equations (7) and (9), it can be seen that Volterra kernels and nonlinear transfer functions specify the system response due to an arbitrary input. Thus, they are input-independent properties of the system, and may fully describe the nonlinear system behaviors. As such, if the original nonlinear transfer functions are approximated in a reduced order model using a method such as moment matching, then the reduced model may accurately model the original nonlinear system properties.

Existing Reduction Techniques

A projection based nonlinear model order reduction approach has been proposed in J. Roychowdhury, “Reduced-order modeling of time-varying systems,” IEEE Trans. Circuits and Systems II: Analog and Digital Signal Processing, vol. 46, no. 10,October, 1999 (hereinafter “Roychowdhury”), and J. Phillips, “Automated extraction of nonlinear circuit macromodels,” Proc. of CICC, 2000 (hereinafter “Phillips”), the disclosures of which are hereby incorporated herein by reference, where reduction techniques for LTI systems are extended to take the weakly nonlinear aspects of a system into consideration. For simplicity of description, consider the expanded state-space model of the nonlinear system in Equation (1)

$$\frac{ⅆ x}{ⅆ t} = {A}_{1} x + {A}_{2} ( x ⊗ x ) + {A}_{3} ( x ⊗ x ⊗ x ) + … + bu . \qquad ( 10 )$$

Similar to Equations (4) through (6), consider the first order through the third order nonlinear responses

$$\begin{matrix}{\dot{x}}_{1} = {A}_{1} {x}_{1} + bu & ( 11 ) \\ {\dot{x}}_{2} = {A}_{1} {x}_{2} + {A}_{2} ( {x}_{1} ⊗ {x}_{1} ) & ( 12 ) \\ {\dot{x}}_{3} = {A}_{1} {x}_{3} + 2 {A}_{2} ( \overline{{x}_{1} ⊗ {x}_{2}} ) + {A}_{3} ( {x}_{1} ⊗ {x}_{1} ⊗ {x}_{1} ) . & ( 13 )\end{matrix}$$

Equations (11) through (13) represent three LTI systems with inputs formed by ux₁\mathring{x}x₁ and

$${\vert {( \overline{{x}_{1} ⊗ {x}_{2}} )}^{T} , {( {x}_{1} ⊗ {x}_{1} ⊗ {x}_{1} )}^{T} \vert}^{T} ,$$

respectively. Each of these LTI systems may be reduced to a smaller system using various projection methods. If the system of Equation (11) with n states is reduced to a system with q₁ states through a Krylov subspace projection x₁=V_{q1}\overline{x}₁, then the inputs to Equation (12) can be approximated by Equation 14 below:

$${x}_{1} ⊗ {x}_{1} = ( {V}_{q1} \cdot {\overline{x}}_{1} ) ⊗ ( {V}_{q1} \cdot {\overline{x}}_{1} ) = ( {V}_{q1} ⊗ {V}_{q1} ) \cdot ( {\overline{x}}_{1} ⊗ {\overline{x}}_{1} ) \qquad ( 14 )$$

This suggests that Equation (12) now can be viewed as having q₁² inputs instead of n² inputs, and can be reduced by a Krylov projection x₂=V_{q2}·\overline{x}₂ to a smaller system with q₂ states. Now the number of inputs to (13) is reduced from n²+n³ to q₁³+q₁q₂. Equation (13) can be reduced to a smaller LTI system with q₃ states via projection x₃=V_{q3}·\overline{x}₃. The final reduced nonlinear model can either be in the form of a collection of reduced linear systems, or be described by a smaller set of nonlinear equations using variable embedding x=V·\overline{x} where V is an orthonormal basis of [V_{q1},V_{q2},V_{q3}]. For the latter case, the third order matrix can be reduced to a matrix of a smaller dimension, such as \overline{A}₃=VA₃(V\mathring{x}V\mathring{x}V). However, the reduced third order matrix is usually dense and has O(q⁴) entries, where q is the number of states of the reduced model. Therefore, achieving model compactness may be effective for model reduction.

An advantage of the above approach is that existing LTI techniques may be applied directly as a black-box tool. There are three major problems that may be associated with this direct extension to LTI based reductions. First, this approach may reduce a weakly nonlinear system by approximating underlying linear subsystems. The assumption is that overall nonlinear behavior of the original system will be closely replicated in the reduced system if the corresponding linear circuits are well approximated. Nevertheless, it may be difficult to assess the quality of the nonlinear system reduction. As a consequence, it remains unclear how the qualities of reduced linear subsystems interact with overall quality of the reduced nonlinear model. Furthermore, there may be a lack of guidance on how to optimize nonlinear model quality by choosing appropriate orders for the reduced linear blocks. Second, it can be seen that this method models a nonlinear system, potentially with a small number of inputs, as several linear systems with many more inputs. Intuitively, this increase in the degree of freedom may lead to unnecessarily large reduced models. Finally, as an extension to LTI based reduction, this approach may not explore flexible selections of expansion points for approximating nonlinear transfer functions. For instance, to capture accurately the third order intermodulation around the center frequency f₀ of a narrow-band amplifier, it may be desirable to expand the third transfer function H(s₁,s₂,s₃), at an expansion point (j2πf₀,j2πf₀,−j2πf₀). This choice of expansion point is relatively difficult to incorporate in the aforementioned reduction approach.

### SUMMARY

According to some embodiments of the present invention, a nonlinear system may be modeled by obtaining a transfer function for the nonlinear system and generating a Taylor series expansion of the transfer function. The Taylor series expansion comprises a plurality of moments respectively corresponding to a plurality of coefficients of the Taylor series terms. At least one Krylov subspace is derived that matches at least one of the plurality of moments. The nonlinear system is modeled using the at least one Krylov subspace.

In other embodiments of the present invention, derivnig the at least one Krylov subspace comprises selecting an order k of the plurality of moments to be matched and deriving at least one Krylov subspace that matches at least one of the kth order moments of the plurality of moments.

In still other embodiments of the present invention, a plurality of sample points is selected and the k+1th order Transfer function is generated at each of the plurality of sample points. The contributions of non-linear elements in the k+1th order Transfer function generated at each of the plurality of sample points are determined. Selected non-linear elements from the k+1th order Transfer function that have lower contributions to the k+1th order Transfer function, for example, are discarded to obtain a pruned system that approximates the k+1th order Transfer function. The nonlinear system is modeled using the at least one Krylov subspace and the pruned system that approximates the k+1th order Transfer function.

In still other embodiments of the present invention, the Taylor series expansion is genearted by generating a plurality of Taylor series expansions of the Transfer function about a plurality of expansion points. Each of the plurality of Taylor series expansions comprises a plurality of moments. An order k of the plurality of moments to be matched is selected based on a number of the plurality of expansion points. At least one Krylov subspace is derived that matches at least one of the kth order moments of respective ones of the plurality of moments for the plurality of expansion points.

In still further embodiments of the present invention, the Taylor series expansion is generated by generating a plurality of Taylor series expansions of the Transfer function about a plurality of expansion points. Each of the plurality of Taylor series expansions comprising a plurality of moments. At least one Krylov subspace is derived that matches at least one of the plurality of moments for the plurality of expansion points.

In still further embodiments of the present invention, the transfer function comprises a single variable transfer function component and a multi-variable transfer function component.

In still furthe embodiments of the present invention, respective ones of the plurality of moments are matrices.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram of a nonlinear system that may be modeled in accordance with some embodiments of the present invention;

FIG. 2 is a block diagram of a data processing system that may be used to model nonlinear systems in accordance with some embodiments of the present invention;

FIG. 3 is a flowchart that illustrates exemplary operations for modeling nonlinear systems in accordance with some embodiments of the present invention;

FIG. 4 is a table that illustrates exemplary operations for modeling nonlinear systems in accordance with some embodiments of the present invention;

FIG. 5 is a diode circuit that is modeled in accordance with some embodiments of the present invention;

FIGS. 6A-6D are graphs that illustrate modeling results using various modeling techniques for the diode circuit of FIG. 5;

FIG. 7 is a mixer circuit that is modeled in accordance with some embodiments of the present invention;

FIGS. 8A-8D are graphs that illustrate modeling results using various modeling techniques for the mixer circuit of FIG. 7;

FIGS. 9A and 9B are simulation results for the mixer circuit of FIG. 7;

FIG. 10 is a directconversion mixer circuit that is modeled in accordance with some embodiments of the present invention;

FIGS. 11A-11D are graphs that illustrate modeling results using various modeling techniques for the directconversion mixer circuit of FIG. 10;

FIG. 12 is a switched capacitor filter that is modeled in accordance with some embodiments of the present invention;

FIGS. 13A-13B are graphs that illustrate modeling results using various modeling techniques for the switched capacitor filter circuit of FIG. 12; and

FIG. 14 is a simulation result for the switched capacitor filter circuit of FIG. 12.

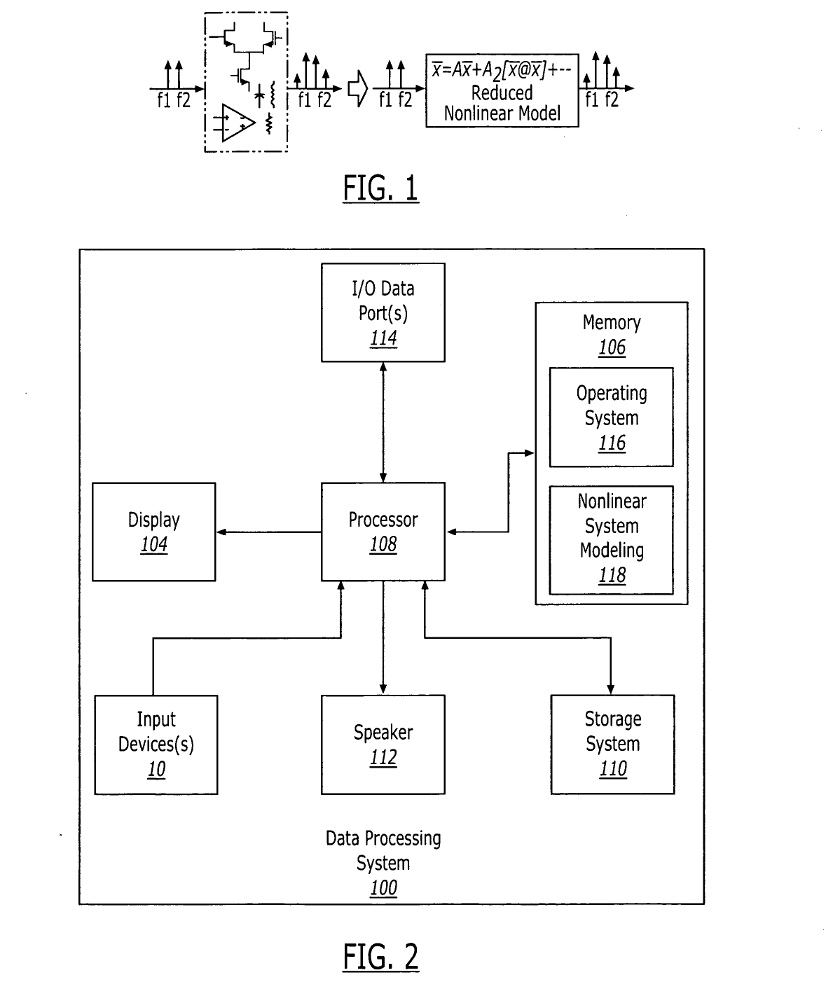

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. As used herein, the term “and/or” includes any and all combinations of one or more of the associated listed items.

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

The present invention may be embodied as methods, data processing systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Referring now to FIG. 2, an exemplary data processing system 100 that may be used to model nonlinear systems, in accordance with some embodiments of the present invention, comprises input device(s) 102, such as a keyboard or keypad, a display 104, and a memory 106 that communicate with a processor 108. The data processing system 100 may further include a storage system 110, a speaker 112, and an input/output (I/O) data port(s) 114 that also communicate with the processor 108. The storage system 110 may include removable and/or fixed media, such as floppy disks, ZIP drives, hard disks, or the like, as well as virtual storage, such as a RAMDISK. The I/O data port(s) 114 may be used to transfer information between the data processing system 100 and another computer system or a network (e.g., the Internet). These components may be conventional components such as those used in many conventional computing devices and/or systems, which may be configured to operate as described herein.

The processor 108 communicates with the memory 106 via an address/data bus. The processor 108 may be, for example, a commercially available or custom microprocessor. The memory 106 is representative of the overall hierarchy of memory devices containing the software and data used to model inductive effects in a circuit, in accordance with embodiments of the present invention. The memory 106 may include, but is not limited to, the following types of devices: cache, ROM, PROM, EPROM, EEPROM, flash, SRAM, and DRAM.

As shown in FIG. 2, the memory 106 may contain up to two or more major categories of software and/or data: the operating system 116 and the nonlinear system modeling module 118. The operating system 116 controls the operation of the computer system. In particular, the operating system 116 may manage the computer system's resources and may coordinate execution of programs by the processor 108. The nonlinear system modeling module 118 may be configured to model a nonlinear circuit or system by generating a Taylor-series expansion of the transfer function of the nonlinear circuit or system. The coefficients of the Taylor series expansion may be referred to as moments with each coefficient typically being a matrix. The nonlinear system modeling module 118 may be further configured to derive one or more Krylov subspaces, which are described in detail below, that match one or more of the moments of the transfer function of the nonlinear circuit or system. The Krylov subspaces that match one or more of the transfer function moments may be used to model or simulate the nonlinear system or circuit. Advantageously, by using Krylov subspaces to match a subset of moments from the transfer function, the nonlinear system or circuit may be modeled with relatively high accuracy. Moreover, the size of the model is generally much smaller than a model based on larger subsets of the moments associated with the nonlinear system or circuit. Indeed, large and/or complex nonlinear systems may have numerous moments when their transfer functions are expanded. Moreover, a transfer function for a nonlinear system may include both a single variable transfer function component and a muti-variable transfer function component, which adds to the number of moments in the expansion of the transfer function.

Although FIG. 2 illustrates an exemplary software architecture that may be used for modeling nonlinear systems or circuits, in accordance with some embodiments of the present invention, it will be understood that the present invention is not limited to such a configuration but is intended to encompass any configuration capable of carrying out the operations described herein.

Computer program code for carrying out operations of the present invention may be written in an object-oriented programming language, such as Java, Smalltalk, or C++. Computer program code for carrying out operations of the present invention may also, however, be written in conventional procedural programming languages, such as the C programming language or compiled Basic (CBASIC). Furthermore, some modules or routines may be written in assembly language or even micro-code to enhance performance and/or memory usage. It will be further appreciated that the functionality of any or all of the program modules may also be implemented using discrete hardware components, a single application specific integrated circuit (ASIC), or a programmed digital signal processor or microcontroller.

The present invention is described hereinafter with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

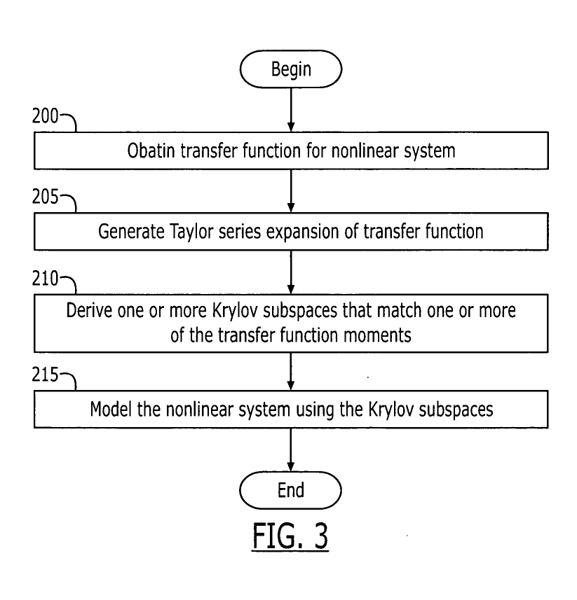

With reference to the flowchart of FIG. 3, exemplary operations of methods, systems, and/or computer program products for modeling nonlinear circuits and/or systems, in accordance with embodiments of the present invention, will be described hereafter. Referring now to FIG. 3, operations begin at block 200 where the nonlinear systems modeling module 118 obtains a transfer function for a nonlinear system and/or circuit to be simulated. A user, for example, may input the transfer function to the data processing system 100 using the input device(s) 102. The nonlinear systems modeling module 118 generates a Taylor series expansion of the transfer function at block 205. The Taylor series expansion of the transfer function includes a plurality of moments that correspond to the coefficients of the Taylor series terms. In accordance with various embodiments of the present invention, the Taylor series expansion may be generated for a single expansion point or for multiple expansion points. For example, for some transfer functions, it may be more accurate to model the transfer function based on moments obtained from multiple expansion points rather than using more moments from a single expansion point.

Returning to FIG. 3, the nonlinear systems modeling module 118 derives one or more Krylov subspaces that match one or more of the transfer function moments at block 210. In accordance with some embodiments of the present invention, an order k of the plurality of moments to be matched may be selected and the Krylov subspaces may be derived to match at least one of the kth order moments. The order k may be selected, for example, in conjunction with the number of expansion points. That is, a greater number of expansion points may be used and a lower value for k may be selected or, alternatively, fewer expansion points may be used and a higher value for k may be selected. The nonlinear system modeling module 118 may use the Krylov subspaces derived at block 210 to model the nonlinear system at block 215.

The flowchart of FIG. 3 illustrates the architecture, functionality, and operations of possible embodiments of the data processing system 100 of FIG. 2. In this regard, each block may represent a module, segment, or portion of code, which comprises one or more executable instructions for implementing the specified logical function(s). It should also be noted that in some alternative embodiments, the functions noted in the blocks may occur out of the order noted in FIG. 3. For example, two blocks shown in succession may in fact be executed substantially concurrently or the blocks may sometimes be executed in the reverse order, depending on the functionality involved.

A detailed mathematical analysis of methods, systems, and/or computer program products for modeling nonlinear systems and/or circuits, in accordance with some embodiments of the present invention, will now be provided.

Matrix-Form Nonlinear Transfer Functions and Moments

To derive the general matrix-form nonlinear transfer functions suitable for model order reduction, without loss of generality we consider Modified Nodal Analysis (MNA) formulation for a single input multiple output (SIMO) based weakly nonlinear system in Equation (1) and its expanded form in Equation (2). The nonlinear transfer functions presented here are the corresponding matrix-form expressions of the analytical nonlinear current method used for computing Volterra kernels. Before proceeding we first introduce the notations used throughout this detailed description.

For matrices in Equation (2) we define

$$A = - {G}_{1}^{- 1} {C}_{1} , {r}_{1} = {G}^{- 1} b , {r}_{2} = {r}_{1} ⊗ {r}_{1} , {r}_{3} = {r}_{1} ⊗ {r}_{1} ⊗ {r}_{1} . \qquad ( 15 )$$

and for an arbitrary matrix F define

$$\begin{matrix}{F}^{l ⊗ m ⊗ … ⊗ n} = {F}^{l} ⊗ {F}^{m} ⊗ … ⊗ {F}^{n} , \overline{{F}^{l ⊗ m}} = \frac{1}{2} ( {F}^{l ⊗ m} + {F}^{m ⊗ l} ) \\ {F}^{l ⊗ m ⊗ n} = \frac{1}{6} ( {F}^{l ⊗ m ⊗ n} + {F}^{l ⊗ n ⊗ m} + {F}^{m ⊗ l ⊗ n} + {F}^{m ⊗ n ⊗ l} + {F}^{n ⊗ l ⊗ m} + \\ {F}^{n ⊗ m ⊗ l} )\end{matrix} \qquad ( 16 )$$

We also define the Krylov subspace K₁(A,p) corresponding to matrix A and vector (matrix) p as the space spanned by vectors {p, Ap, . . . A¹p}.

For the systems in Equations (1) and (2), the first order transfer function for state-variables x is simply the transfer function of the linearized system
(G₁+sC₁)H₁(s)−b, or H₁(s)−(G₁+sC₁)⁻¹b. (17)
Defining \overline{s}−s₁+s₂, it can be shown that the second transfer function is determined by

$$\vert {G}_{1} + {sC}_{1} \vert {H}_{2} ( {s}_{1} \cdot {s}_{2} ) -- \vert {G}_{2} + \overline{s} {C}_{2} \vert \cdot \overline{{H}_{1} ( {s}_{1} ) ⊗ {H}_{1} ( {s}_{2} )} , \qquad ( 18 )$$

where

$$\overline{{H}_{1} ( {s}_{1} ) ⊗ {H}_{1} ( {s}_{2} )} = \frac{1}{2} ( {H}_{1} ( {s}_{1} ) ⊗ {H}_{1} ( {s}_{2} ) + {H}_{1} ( {s}_{2} ) ⊗ {H}_{1} ( {s}_{1} ) ) .$$

We similarly define

$$\vec{{H}_{1} ( {s}_{1} ) ⊗ {H}_{1} ( {s}_{2} ) ⊗ {h}_{1} ( {s}_{3} )}$$

as the arithmetic average of terms of all possible permutations of frequency variables in the Kronecker product. Define \grave{s}−s₁+s₂+s₃, then the third order nonlinear transfer function is given by the following equations

$$\begin{matrix}\vert {G}_{1} + {s}^{‵} {C}_{1} \vert {H}_{3} ( {s}_{1} , {s}_{2} , {s}_{3} ) = - \vert {G}_{3} + {s}^{‵} {C}_{3} \vert \cdot \overline{{H}_{1} ( {s}_{1} ) ⊗ {H}_{1} ( {s}_{2} ) ⊗ {H}_{1} ( {s}_{3} )} - 2 \cdot \vert {G}_{2} + {s}^{‵} {C}_{2} \vert \cdot \overline{{H}_{1} ( {s}_{1} ) ⊗ {H}_{2} ( {s}_{2} , {s}_{3} )} & ( 19 ) \\ \begin{matrix}\overline{{H}_{1} ( {s}_{1} ) ⊗ {H}_{2} ( {s}_{2} , {s}_{3} )} = \frac{1}{6} ( {H}_{1} ( {s}_{1} ) ⊗ {H}_{2} ( {s}_{2} , {s}_{3} ) + {H}_{1} ( {s}_{2} ) ⊗ {H}_{2} ( {s}_{1} , {s}_{3} ) + \\ {H}_{1} ( {s}_{3} ) ⊗ {H}_{2} ( {s}_{1} , {s}_{2} ) + {H}_{2} ( {s}_{1} , {s}_{2} ) ⊗ {H}_{1} ( {s}_{3} ) + \\ {H}_{2} ( {s}_{1} , {s}_{3} ) ⊗ {H}_{1} ( {s}_{2} ) + {H}_{2} ( {s}_{2} , {s}_{3} ) ⊗ {H}_{1} ( {s}_{1} ) )\end{matrix} & ( 20 )\end{matrix}$$

Without loss of generality, expand Equation (17) at the origin as a Mclaurin series

$${H}_{1} ( s ) - {\sum }_{k = 0}^{-} {s}^{k} {A}^{k} {r}_{1} - {\sum }_{k = 0}^{-} {s}^{k} {M}_{1 , k} , \qquad ( 21 )$$

where M_{1,k}−A^{k}r₁ is the kth order moment of the first order transfer function. Expand H₂(s₁,s₁) at the origin (0,0), we have

$${H}_{2} ( {s}_{1} , {s}_{2} ) - {\sum }_{k = 0}^{-} {\sum }_{l = 0}^{k} {s}_{1}^{l} {s}_{2}^{k - l} {M}_{2 , k , l} , \qquad ( 22 )$$

where M_{2,k,1} is the kth order moment for the second order transfer function. To derive the expressions for the moments of H₂(s₁,s₂), substituting Equation (21) into Equation (18) and expanding w.r.t. \overline{s}−s₁+s₂ yields

$$\begin{matrix}{H}_{2} ( {s}_{1} , {s}_{2} ) = - {[ {G}_{1} + \overline{s} {C}_{1} ]}^{- 1} \cdot [ {G}_{2} + \overline{s} {C}_{2} ] \cdot \overline{{H}_{1} ( {s}_{1} ) ⊗ {H}_{1} ( {s}_{2} )} \\ = - {\sum }_{m = 0}^{-} {\overline{s}}^{m} {A}^{m} {G}_{1}^{- 1} \cdot [ {G}_{2} + s {C}_{2} ] \cdot \overline{( {\sum }_{k = 0}^{-} {s}_{1}^{k} {M}_{1 , k} ) ⊗ ( {\sum }_{l = 0}^{-} {s}_{2}^{l} {M}_{1 , l} )} \\ = - {\sum }_{m = 0}^{-} {\sum }_{k = 0}^{-} {\sum }_{l = 0}^{-} {\overline{s}}^{m} {s}_{1}^{k} {s}_{2}^{l} {A}^{m} {G}_{1}^{- 1} \cdot ( {G}_{2} + \overline{s} {C}_{2} ) \overline{{A}^{k ⊗ l}} {r}_{2}\end{matrix} \qquad ( 23 )$$

Comparing (22) with (23), we can express the moments of H₂(S₁,s₂) as

$${M}_{2 , k , l} = - {\sum }_{p = 1}^{k} {A}^{p - 1} {\sum }_{q = 0 , q \leq l , p - q \leq k - 1}^{p} ( \begin{matrix}p \\ q\end{matrix} ) {G}_{1}^{- 1} {C}_{2} \cdot \overline{{A}^{( l - q ) ⊗ ( k - l - p - q )}} {r}_{2} - {\sum }_{p = 0}^{k} {A}^{p} {\sum }_{q = 0 , q \leq l , p - q \leq k - 1}^{p} ( \begin{matrix}p \\ q\end{matrix} ) {G}_{1}^{- 1} {G}_{2} \cdot \overline{{A}^{( l - q ) ⊗ ( k - l - p - q )}} {r}_{2}^{′} \qquad ( 24 )$$

Similarly, the third order transfer function can be expanded at the origin (0,0,0) as

$${H}_{3} ( {s}_{1} , {s}_{2} , {s}_{3} ) = {\sum }_{k = 0}^{-} {\sum }_{l = 0}^{k} {\sum }_{m = 0}^{k - l} {s}_{1}^{l} {s}_{2}^{m} {s}_{3}^{k - l - m} {M}_{3 , k , l , m} . \qquad ( 25 )$$

where M_{3,k,1,m} is a kth order moment given by

$$\begin{matrix}{M}_{3 , k , l , m} = - {\sum }_{p = 1}^{k} {A}^{p - 1} {\sum }_{q = 0 , q \leq l , p - q \leq k - 1}^{p} ( \begin{matrix}p \\ q\end{matrix} ) {\sum }_{t = 0 , t \leq m , p - t - q \leq k - l - m}^{p - q} ( \begin{matrix}p - q \\ t\end{matrix} ) \\ {G}_{1}^{- 1} [ {C}_{3} \cdot \overline{{A}^{( l - q ) ⊗ ( m - t ) ( k - l - m - p + q + t )}} {r}_{3} + {C}_{2} \cdot F ] - \\ - {\sum }_{p = 0}^{k} {A}^{p} {\sum }_{q = 0 , q \leq l , p - q \leq k - 1}^{p} ( \begin{matrix}p \\ q\end{matrix} ) {\sum }_{t = 0 , t \leq m , p - t - q \leq k - l - m}^{p - q} ( \begin{matrix}p - q \\ t\end{matrix} ) \\ {G}_{1}^{- 1} [ {G}_{3} \cdot \overline{{A}^{( l - q ) ⊗ ( m - t ) ⊗ ( k - l - m - p + q + t )}} {r}_{3} + {G}_{2} \cdot F ]\end{matrix} \qquad ( 26 )$$

with

$$\begin{matrix}F = \frac{1}{3} [ ( {A}^{l - q} r ) ⊗ {M}_{2 , k - l - p + q , m - t} + ( {A}^{m - t} r ) ⊗ {M}_{2 , k - m - p + t , l - q} + \\ ( {A}^{k - l - m - p + q + t} r ) ⊗ {M}_{2 , l + m - q - t , l - q} + {M}_{2 , k - l - p + q , m - t} ⊗ \\ ( {A}^{l - q} r ) + {M}_{2 , k - m - p + t , l - q} ⊗ ( {A}^{m - t} r ) + {M}_{2 , l + m - q - t , l - q} ⊗ \\ ( {A}^{k - l - m - p + q + t} r ) ]\end{matrix} \qquad ( 27 )$$

As an example, the first few moments of H₂(s₁,s₂) are shown in Table 1. It can be clearly seen that significantly more moments have to be considered to match a nonlinear transfer function than a linear one while the order of moment matching is kept the same. This means nonlinear model order reduction may be intrinsically more complex and costly than that of LTI systems. Also note that in Equations (18) and (19), symmetric nonlinear transfer functions (symmetric w.r.t frequency variable permutations) are used, which is generally advantageous for model reduction as it reduces the number of moments that may need to be matched for H₂ and H₃ approximately by a factor of 2 and 6 respectively, when expanding them at a point with equal coordinates such as the origin.

TABLE 1
Moments of H₂(s₁, s₁)

| Order | Moment |
|---|---|
| 0th order | $- {G}_{1}^{- 1} {G}_{2} {r}_{2}$ |
| 1st order (s₁, sₛterms) | $- {G}_{1}^{- 1} {C}_{2} {r}_{2} - {AG}_{1}^{- 1} {G}_{2} {r}_{2} - \frac{1}{2} {G}_{1}^{- 1} {G}_{2} \vert A ⊗ l + l ⊗ A ] {r}_{2}$ |
| $\begin{matrix}2 nd order \\ ( {s}_{1}^{2} , {s}_{2}^{2} terms )\end{matrix}$ | $- {AG}_{1}^{- 1} {C}_{2} {r}_{2} - {G}_{1}^{- 1} {C}_{2} \overline{{A}^{1 ⊗ 0}} {r}_{2} - {A}^{2} {G}_{1}^{- 1} {G}_{2} {r}_{2} - {AG}_{1}^{- 1} {G}_{2} \overline{{A}^{1 ⊗ 0}} {r}_{2} - {G}_{1}^{- 1} {G}_{2} \overline{{A}^{2 ⊗ 0}} {r}_{2}$ |
| 2nd order (s₁s₂ term) | $- {G}_{1}^{- 1} {C}_{2} \overline{{A}^{1 ⊗ 0}} {r}_{2} - {G}_{1}^{- 1} {G}_{2} {A}^{1 ⊗ 1} {r}_{2} - {AG}_{1}^{- 1} {G}_{2} \overline{{A}^{1 ⊗ 0}} {r}_{2}$ |

NORM

In this section we present some embodiments of the invention, also referred to herein as NORM, but limit our discussion to SIMO time-invariant weakly nonlinear systems. Up to the third order nonlinear transfer functions are considered in the reduction. Extension to more general time-varying systems can be easily derived using time-varying Volterra series as a system description. To assess the model order reduction quality from a moment matching perspective, we first have the following definition:
Definition 1. A nonlinear reduced order model is a kth order model in H₁(s) (H₂(s₁,s₂) or H₃(s₁,s₂,s₃)) if an only if up to kth order moments M_{1,l} , 0 ≦l≦k, (M_{2,l,m,} 0≦l≦k, 0≦m≦l or M_{3,l,m,n,} 0≦l≦k, 0≦m≦l, 0≦n≦l−m) of the first (second or third) order transfer function of the original system defined in Equations (21) ((22) or (25)) are preserved in the reduced model.
   According to definition 1, a 2nd order reduced model in H₂ preserves moments of H₂ corresponding to the coefficients of terms s₁⁰(s₂⁰),s₁,s₂,s₁s₂, s₁² and s₂² in the expansion.
   A. Single-Point Expansion

To derive a set of minimum Krylov subspaces for the most compact order reduction, understanding the interaction between the moments of nonlinear transfer functions at different orders may be beneficial. For the moment matching of H₂(s₁,s₂), this interaction is manifested in Equation (23). A particular term corresponding to s₁^{p}s₂^{q} in the expansion of H₂, where p, q are integers, is a consequence of the two power series expansions: expansion of H₁ in (17) and the expansion w.r.t. \overline{s}=s₁+s₂ of Equation (18). For instance, the kth order moment of H₂ depends on moments of H₁ with an order less than or equal to k. As such, the final expression for M_{2,l,m} is in the form as shown in Equation (24). The expression for M_{3,l,m,n} is derived similarly in a more complex form in Equation (25).

If we were to use a projection for order reduction, one issue is to find certain Krylov subspaces that contain the directions of all the moments to be matched. To minimize the number of projection vectors needed, nonlinear transfer function moments are considered explicitly. A close inspection of Equation (24) reveals that the Krylov subspaces of matrix A given in Table 2 are the desired Krylov subspaces of the minimum total dimension for constructing a kth order model in H₂. For the last row, m=└k/2┘, n=k−└k/2┘, p=└(k−1)/2┘, and q=k−1−(k−1)/2. We denote the union of Krylov subspaces in Table 2 as

$$K2 ( k ) = {⋃}_{i} {K}_{{m}_{t}} ( A , {v}_{i} ) ,$$

where k in the parenthesis indicates the order of H₂ moments up to which contained in the subspaces.

TABLE 2
Krylov subspaces spanned by moments of H₂

| | Subspace | | Subspace |
|---|---|---|---|
| Starting vector vᵢ | Dim m_{i,} | Starting vector vᵢ | Dim mᵢ |
| $\begin{matrix}{G}_{1}^{- 1} {G}_{2} \overline{{A}^{0 ⊗ 0}} {r}_{2} \\ {G}_{1}^{- 1} {G}_{2} \overline{{A}^{1 ⊗ 0}} {r}_{2} \\ … \\ {G}_{1}^{- 1} {G}_{2} \overline{{A}^{k ⊗ 0}} {r}_{2}\end{matrix}$ | $\begin{matrix}k + 1 \\ k \\ … \\ 1\end{matrix}$ | $\begin{matrix}{G}_{1}^{- 1} {C}_{2} \overline{{A}^{0 ⊗ 0}} {r}_{2} \\ {G}_{1}^{- 1} {C}_{2} \overline{{A}^{1 ⊗ 0}} {r}_{2} \\ … \\ {G}_{1}^{- 1} {C}_{2} \overline{{A}^{( k - 1 ) ⊗ 0}} {r}_{2}\end{matrix}$ | $\begin{matrix}k \\ k - 1 \\ … \\ 1\end{matrix}$ |
| $\begin{matrix}{G}_{1}^{- 1} {G}_{2} \overline{{A}^{1 ⊗ 1}} {r}_{2} \\ {G}_{1}^{- 1} {G}_{2} \overline{{A}^{2 ⊗ 0}} {r}_{2} \\ … \\ {G}_{1}^{- 1} {G}_{2} \overline{{A}^{( k - 1 ) ⊗ 1}} {r}_{2}\end{matrix}$ | $\begin{matrix}k - 1 \\ k - 2 \\ … \\ 1\end{matrix}$ | $\begin{matrix}{G}_{1}^{- 1} {C}_{2} \overline{{A}^{1 ⊗ 1}} {r}_{2} \\ {G}_{1}^{- 1} {C}_{2} \overline{{A}^{2 ⊗ 1}} {r}_{2} \\ … \\ {G}_{1}^{- 1} {C}_{2} \overline{{A}^{( k - 2 ) ⊗ 1}} {r}_{2}\end{matrix}$ | $\begin{matrix}k - 2 \\ k - 3 \\ … \\ 1\end{matrix}$ |
| . . . | . . . | . . . | . . . |
| ${G}_{1}^{- 1} {G}_{2} \overline{{A}^{m ⊗ n}} {r}_{2}$ | 1 | ${G}_{1}^{- 1} {C}_{2} \overline{{A}^{q ⊗ p}} {r}_{2}$ | 1 |

In an analogous and somewhat more involved way, a set of minimum Krylov subspaces K3(k) for moment-matching of H₃ up to the kth order can also be derived. More specifically, Equations 26 and 27 show that the subspace

$$K3 ( k ) = {⋃}_{i} {K}_{{m}_{t}} ( A , {v}_{i} )$$

consists of a collection of Krylov subspaces of A, where the starting vector vᵢ takes one of the following forms set forth below in Equations (28) and (29):
with

$${G}_{1}^{- 1} {G}_{3} \vec{{A}^{l ⊗ m ⊗ n}} {r}_{3} , {G}_{1}^{- 1} {C}_{3} \overline{{A}^{l ⊗ m ⊗ n}} {r}_{3} , \\ {G}_{1}^{- 1} {G}_{2} \overline{( {A}^{1} {r}_{1} ) ⊗ {M}_{2 ( m , n )}} , or {G}_{1}^{- 1} {C}_{2} \overline{( {A}^{1} {r}_{1} ) ⊗ {M}_{2 ( m , n )}} . \qquad ( 28 )$$

$$\begin{matrix}\overline{( {A}^{l} r ) ⊗ {M}_{2 ( m , n )}} = \frac{1}{3} ( ( {A}^{l} {r}_{1} ) ⊗ {M}_{2 , m + n , n} + ( {A}^{m} {r}_{1} ) ⊗ {M}_{2 , l + n , n} + \\ ( {A}^{n} {r}_{1} ) ⊗ {M}_{2 , l + n , l} + {M}_{2 , m + n , n} ⊗ ( {A}^{l} {r}_{1} ) + {M}_{2 , l + n , n} ⊗ \\ ( {A}^{m} {r}_{1} ) + {M}_{2 , l + n , l} ⊗ ( {A}^{m} {r}_{1} ) )\end{matrix} \qquad ( 29 )$$

Using these subspaces, Theorem 1 may be proved below as follows:
Theorem 1: if V=qr([kₖ_{₁}₊₁(A,r₁), K2(k₂), K3(k₃)]) where k₁≧k₂≧k₃, is orthonormal basis for the union of subspaces Kₖ_{₃}₊₁(A,r₁),K2(k₂) and K3(k₃), then for Equation (1) or Equation (2), the reduced order model specified by the following system matrices

$$\begin{matrix}{\tilde{G}}_{1} = {V}^{T} {G}_{1} V , {\tilde{C}}_{1} = {V}^{T} {C}_{1} V , \tilde{b} = {V}^{T} b , \tilde{d} = {V}^{T} d \\ {\tilde{G}}_{2} = {V}^{T} {G}_{2} ( V ⊗ V ) , {\tilde{C}}_{2} = {V}^{T} {C}_{2} ( V ⊗ V ) \\ {\tilde{G}}_{3} = {V}^{T} {G}_{3} ( V ⊗ V ⊗ V ) , {\tilde{C}}_{3} = {V}^{T} {C}_{3} ( V ⊗ V ⊗ V )\end{matrix} \qquad ( 30 )$$

is a k₁th order model in H₁, a k₂th order model in H₂, and a k₃th order model in H₃, i.e.,
M_{1,l}=V·\grave{M}_{1,l} for all 0≦l≦k₁ (31)
M_{2,l,m}=V·M_{2,l,m} for all 0≦l≦k₂, 0≦m≦l. (32)
M_{3,l,m,n}=V·M_{d,l,m,n} for all 0≦l≦k₃, 0≦m≦l, 0≦n≦l−m. (33)
Proof. Because the subspace Kₖ_{₁}₊₁(A,r₁) is contained in the space spanned by V, Equation 31 is valid as proven in [6]. To prove Equation 32, notice that any M_{2,l,m}(l≦m) can be expressed as a linear combination of Krylov subspace vectors in Table 2. Therefore, it suffices to show that all the Krylov vectors in Table 2 are preserved through the projection. For any Krylov subspace Kᵢ=Kₘ_{₁}(A, vᵢ) in K2(k₂), where vᵢ takes either the form

$${G}_{1}^{- 1} {G}_{2} \vec{{A}^{m ⊗ n}} {r}_{2} ( m + n + {m}_{i} - 1 = {k}_{2} ) or$$

$${G}_{1}^{- 1} {C}_{2} \vec{{A}^{m ⊗ n}} {r}_{2} ( m + n + {m}_{i} = {k}_{2} ) ,$$

using induction it can be shown that its Krylov vectors are preserved in the projection, i.e.,

$${A}^{l} {v}_{i} = {\tilde{A}}^{l} {\tilde{v}}_{i} , 0 \leq l \leq {m}_{i} - 1. \qquad ( 34 )$$

Without loss of generality, consider the former case where

$${v}_{i} = {G}_{1}^{- 1} {G}_{2} \vec{{A}^{m ⊗ n}} {r}_{2} .$$

For the reduced order model, we write

$$\begin{matrix}{\tilde{v}}_{i} = {\tilde{G}}_{1}^{- 1} {\tilde{G}}_{2} \vec{{\tilde{A}}^{m ⊗ n}} {\tilde{r}}_{2} \\ {\tilde{G}}_{1} \tilde{v} = {\tilde{G}}_{2} \vec{{\tilde{A}}^{m ⊗ n}} {\tilde{r}}_{2}\end{matrix} \qquad ( 35 )$$

Substituting Equations (30) and (31) into Equation (35),

$$\begin{matrix}{V}^{T} {G}_{1} {Vv}_{i} = \frac{1}{2} {V}^{T} {G}_{2} ( V ⊗ V ) ( ( {{A}^{‵}}^{m} {r}_{1} ) ⊗ ( {{A}^{‵}}^{n} {{r}^{‵}}_{1} ) + ( {{A}^{‵}}^{n} {{r}^{‵}}_{1} ) ⊗ ( {{A}^{‵}}^{m} {{r}^{‵}}_{1} ) ) \\ = \frac{1}{2} {V}^{T} {G}_{2} ( ( V {{A}^{‵}}^{m} {{r}^{‵}}_{1} ) ⊗ ( V {{A}^{‵}}^{n} {{r}^{‵}}_{1} ) + ( V {{A}^{‵}}^{n} {{r}^{‵}}_{1} ) ⊗ ( V {{A}^{‵}}^{m} {{r}^{‵}}_{1} ) ) \\ = \frac{1}{2} {V}^{T} {G}_{2} ( ( {A}^{m} {r}_{1} ) ⊗ ( {A}^{n} {r}_{1} ) + ( {A}^{n} {r}_{1} ) ⊗ ( {A}^{m} {r}_{1} ) )\end{matrix} \qquad ( 36 )$$

For the original system, similar to Equation (35), we have

$${G}_{1} {v}_{i} = \frac{1}{2} {G}_{2} ( ( {A}^{m} {r}_{1} ) ⊗ ( {A}^{n} {r}_{1} ) + ( {A}^{n} {r}_{1} ) ⊗ ( {A}^{m} {r}_{1} ) ) . \qquad ( 37 )$$

Because V is an orthonormal basis for the subspace, vᵢ can be expressed as a unique linear combination of column vectors of v
vᵢ=V\overline{v}. (38)
Substituting Equation (38) into Equation (37) and multiplying both sides of the equation by V^{T} we get

$${V}^{T} {G}_{1} V {v}^{‵} = \frac{1}{2} {V}^{T} {G}_{2} ( ( {A}^{m} {r}_{1} ) ⊗ ( {A}^{n} {r}_{1} ) + ( {A}^{n} {r}_{1} ) ⊗ ( {A}^{m} {r}_{1} ) ) . \qquad ( 39 )$$

Assuming V^{T}G₁V is full-rank (the reduced system has defined DC solutions). Comparing Equation (39) with Equation (36), it can be seen that

$$\tilde{v} = {\tilde{v}}_{i} , or {v}_{i} = V {\tilde{v}}_{i} ,$$

i.e., Equation (34) holds for l=0. Suppose Equation 34) holds for an arbitrary l=p<mᵢ−1

$$\begin{matrix}{A}^{p} {v}_{i} = V {\tilde{A}}^{p} {\tilde{v}}_{i} & ( 40 ) \\ {A}^{p + 1} {v}_{i} = AV {\tilde{A}}^{p} {\tilde{v}}_{i} . & ( 41 )\end{matrix}$$

A^{p+1}vᵢ can be expressed as a unique linear combination of column vectors V as A^{p+1}vᵢ=V\grave{v}ₚ₊₁, then, after multiplying both sides of Equation (41) by V^{T} Equation (42) is obtained below:

$${V}^{T} V {\tilde{v}}_{p + 1} = {\tilde{v}}_{p + 1} = {V}^{T} AV {\tilde{A}}^{p} {\tilde{v}}_{i} = {\tilde{A}}^{p + 1} {\tilde{v}}_{i} . \qquad ( 42 )$$

which is the same as A^{p+1}vᵢ=VÀ^{p+1}\grave{v}ᵢ. By induction, Equation (34) is true for all l, 0≦l≦mᵢ−1, which proves Equation (32). Equation (33) can be proven in a similar manner.

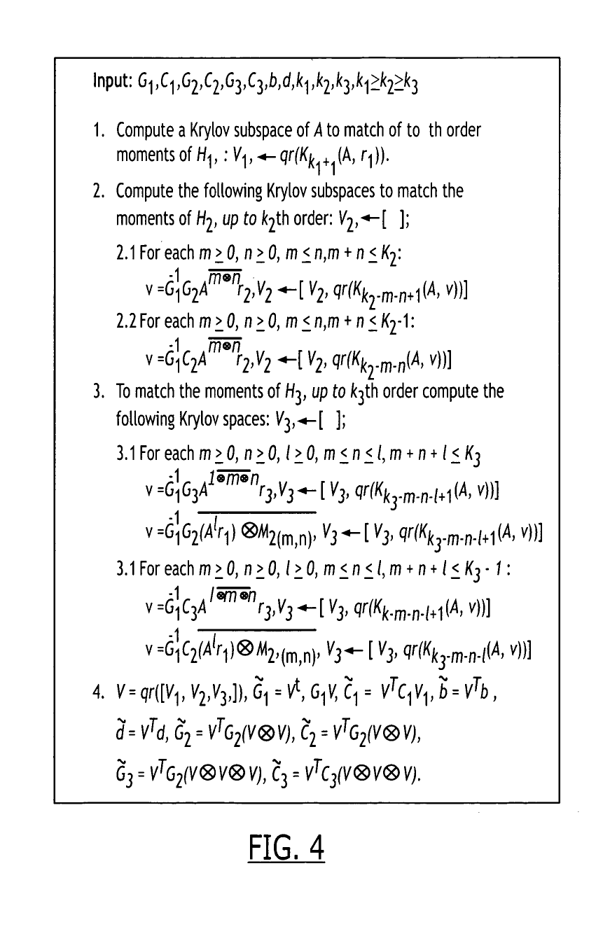

The complete single-point version of the NORM methodology (expanded at the origin) is shown in FIG. 4, where qr() indicates the QR procedure used for othonormalizing the input vectors. The Kronecker product form of the starting vectors of the required Krylov subspace involves power terms of matrix A. This means a direct computation of starting vectors, which depend on high power terms of A, which might not be numerically stable due to machine round off errors. A remedy to this problem for reducing H₂ is to not only use orthogonalization within each individual Krylov subspace but to also use orthogonalization among starting vectors of different Krylov subspaces. A completely stable orthogonalization procedure for the reduction of H₃ may increase the size of the reduced model. Nevertheless, as will be demonstrated in the circuit examples, due to the model size limitation on nonlinear model reduction only a low-order moment-matching (e.g., <6th order, which preserves many more total number of moments is feasible. Therefore, for practical usage, numerical instability is usually not an issue compared to the compactness of the reduced order model. This potential numerical instability can be also reduced by using a multipoint approach as presented below, which further improves the model compactness.

Also note that in FIG. 4, to compute any Kronecker product term, one can exploit the original problem sparsity such that the computation takes only a linear time in the problem size. The requirement of k₁≧k₂≧k₃, is due to the dependence of high order nonlinear transfer functions on transfer functions of lower orders. Provided this condition is satisfied, the order of moment matching for each nonlinear transfer function can be flexibly chosen to fit specific needs. For each of these choices, a reduced order model of minimum size is produced as described in the following section.

Size of Reduced Order Models

Without causing ambiguity, we define the size of a state-equation model in terms of its number of states. Consider the size of the SIMO based reduced order models generated using the methods of Roychowdhury and Phillips under Definition 1. It can be shown that if the linear networks described by Equations (11)-(13) are each reduced to a system preserving up to k₁, k₂, and k₃th order moments of the original system, respectively, then the overall reduced nonlinear model is a k₁th order model in H₁, a \overline{k}₂th order model in H₂, where \overline{k}₂=min(k₁,k₂) and a \overline{k}₃th order model in H₃, where \overline{k}₃=min(k₁,k₂,k₃). For example, from Equation (23), the final moment expressions of H₂ are a consequence of expanding with respect to s in Equation (17) and expanding with respect to \overline{s} in Equation (18). Therefore, the lesser of k₁ and k₂ determines the order up to which the moments of H₂(s₁,s₂) are matched. This reveals that for this method, the most compact kth order model in H₂ with a size in O(k³) is achieved by choosing k₁=k₂=k. In other words, choosing k₂>k₁=k does not necessarily increase the number of moments of H₂ matched in the reduced model. On the other hand, if one would like to have k₁>k₂ to increase the accuracy of H₁, one way is to only make use of the first k_{2·}+1 moment directions of H₁ for reducing H₂ while the remaining H₁ moments are included in the projection only for matching H₁ itself, i.e., only a k_{2·}+1th reduced model of the system in Equations (4) or (11) is computed when reducing the second order system in Equations (5) or (12). Similar strategies apply to reducing Equation (13) for the moment matching of H₃ such as the optimal way to generate a kth order model in H₃ is to choose k₁=k₂=k₃=k with a resulting model size of O(k⁵). Note that these strategies are also used in the single point NORM algorithm. To compare with the above “optimal” model sizes achievable using the methods of Roychowdhury and Phillips, using the single-point NORM, the sizes of a kth order model in H₂ and H₃ are in O(k³) and O(k⁴), respectively. The exact model sizes for several values of k will be shown in the following section.

Multi-Point Expansions

To target a system's particular input frequency band of interest, particularly for RF circuits, it may be desirable to expand both linear and nonlinear transfer functions at points other than the origin such as along the imaginary axis. Under nonlinear context, a single-frequency expansion point along the imaginary axis may inherit multiple matrix factorizations due to the nonlinear frequency mixing effects. To this end, suppose that the in-band third order intermodulation of a nonlinear system around center frequency fₒ is important to model. To build the most compact model, one would opt to expand H₁(s) at s=j2πfₒ, but to correctly perform moment matching for H₂ and H₃, the respective expansion points for high order transfer functions should be (j2πfₒ,j2πfₒ) and (j2πfₒ,j2πfₒ) for H₂ , and (j2πfₒ,j2πfₒ,−j2πfₒ) for H₃, respectively. Here the use of two expansion points for H₂ takes care of matching second order mixing effects in terms of both sum and difference frequencies around the center frequency, and also ensures the moment matching of the third order in-band intermodulations. These choice of expansion points require the system matrix factorized at DC and j4πfₒ but not j2πfₒ Equations (12)-(13) or (18)-(19). Therefore, if every linear system in Equations (11 )-(13) is reduced by expanding at s=j2πfₒ using conventional methods, then there is no guarantee for matching any moments H₂ and H₃.

In addition to the benefit of using a specific expansion point, a multiple-point projection where several expansion points are used simultaneously has a unique efficiency advantage in terms of model compactness over the single-point method. Although multiple-point methods may not bring such an advantage for LTI system reduction, adopting multiple-point methods for nonlinear systems can lead to significantly smaller reduced models. To see this, notice that in Table 3 the size of the nonlinear reduced order model grows faster than the order of moment matching.

TABLE 3
Comparison of the reduced order model sizes

| Order K | 3 | 4 | 5 | 6 | 7 | 8 | 9 |
|---|---|---|---|---|---|---|---|
| Roychowdhury/Phillips: | 116 | 230 | 402 | 644 | 968 | 1386 | 1910 |
| H1-H2 | | | | | | | |
| NORM-sp: H1-H2 | 24 | 40 | 62 | 91 | 128 | 174 | 230 |
| NORM-mp: H1-H2 | 14 | 20 | 27 | 35 | 44 | 54 | 65 |
| Roychowdhury/Phillips: | 3700 | 11480 | 28914 | 63070 | 123848 | 224460 | 381910 |
| H1-H2-H3 | | | | | | | |
| NORM-sp: H1-H2-H3 | 66 | 118 | 194 | 301 | 446 | 636 | 880 |
| NORM-mp: H1-H2-H3 | 34 | 55 | 83 | 119 | 164 | 219 | 285 |

This stems from the fact as the order of moment matching proceeds, significantly more moments corresponding to various expansion terms emerge for multiple-variable high order transfer functions. However, it is much more revealing to recognize that the numbers of up to kth order moments of H₂ and H₃ are k(k+1)/2 and O(k³) respectively, i.e., the dimension of the subspaces used in the reduction grows even faster than the number of moments matched in the single-point expansion version of NORM. Using the bilinear form can produce models with a size proportional to the number of moments matched; however, this may be offset by the inflated problem size and the accuracy degradation for reducing a significantly larger system. In contrast, to preserve the value of a nonlinear transfer function at a specific point (a zeroth-order moment), for example, only one vector needs to be included in the projection assuming the dependency between transfer functions of different orders is resolved properly, i.e., the reduced model size of a zero-th order multiple-point method is the same as the number of moments matched. For the state-equation form of Equation (2), we compare the worst-case reduced model sizes generated by the methods listed in Table 3, where each method is used to match the moments of H₂ or H₂ & H₃ up to kth order. In the table, the “optimal” strategies outlined in previous sections are used for the conventional methods. NORM(sp) denotes the single-point based NROM, and NORM(mp) is the “equivalent” zeroth-order multiple-point method preserving the same total number of moments. As clearly shown, using NORM the model compactness has been significantly improved.

In practice one would trade-off computational efficiency with the model compactness by using a multiple-point based approach where low-order moment-matching is performed at several expansion points. The added computational cost incurred by more matrix factorizations in this approach might be alleviated by exploiting the idea of recycled Krylov-subspace vectors for time-varying systems. It is also possible to use constant Jacobian iterations to iteratively solve the resulted linear problems for narrow band systems, such as certain RF applications. The LU factorization at one expansion point might be reused at another point not far apart as an approximated Jacobian in the iteration. One extra advantage of multiple-point methods is that they help to eliminate the potential numerical stability problem of the single-point methods for high order moment matching.

Numerical Results

Using various examples, NORM modeling of systems (single-point NORM (NORM-sp) and zeroth-order multiple-point NORM (NORM-mp)) has been compared with the modeling methodologies described in Roychowdhury and Phillips. For the Roychowdhury/Phillips method and single-point NORM method, the origin was chosen as the expansion point. Note that the strategies presented in the section entitled “Size Of Reduced Order Models” were applied to the Roychowdhury/Phillips method; otherwise, significantly larger models resulted with little accuracy improvement. For all three methods, an SVD procedure follows the computation of Krylov subspace vectors to deflate the subspaces as much as possible.

A Diode Circuit Example

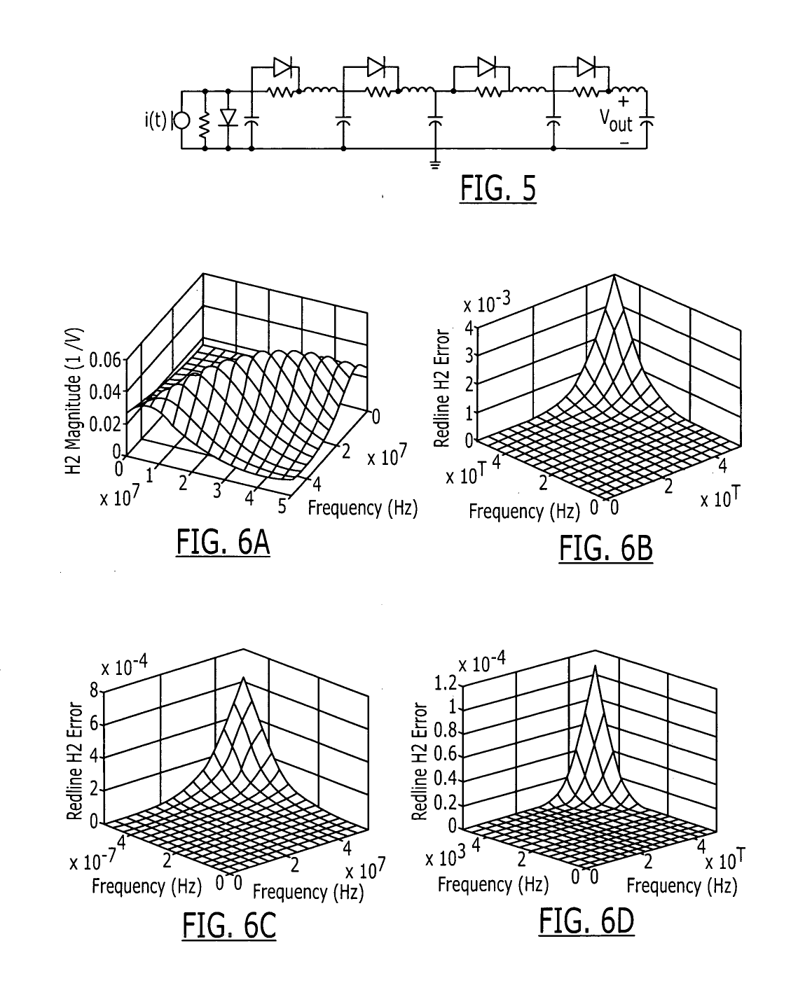

We first consider a diode circuit as shown in FIG. 5 with one inductor added to each diode/resistor/capacitor stage. The circuit consists of 250 stages or 751 state variables. The input is a small-signal current source, and the output is the capacitor voltage at the last stage. Each diode's nonlinear I—V characteristics is modeled using a second order polynomial at the bias point. The Roychowdhury/Phillips method generates a model of 45 states matching 5 moments of H₁, 2 moments of both H₂ and H₃.

NORM-sp matches 5 moments of H₁, 9 moments of H₂, 4 moments of H₃, resulting in a reduced model with 23 stages. NORM-mp produces a model with 18 states while matching 5 moments of H₁, 10 moments of H₂ and 4 moments of H₃. As can be seen, NORM is able to generate a smaller model while matching more moments due to its improved selection of Krylov subspace vectors. The second order transfer functions of H₂(j2πf₁, j2πf₂), where 0≦f₁,f₂≦50 MHz is plotted based on the full model in FIG. 6A, the Roychowdhury/Phillips model in FIG. 6B, the NORM-sp model in FIG. 6C, and the NORM-mp model in FIG. 6D. The maximum relative errors of the Roychowdhury method, NORM-sp method, and NORM-mp method are about 0.35%, 0.06% and 0.011%, respectively. For our simulation using harmonic balance, we applied a 5 MHz sinusoidal input with a 1 mv magnitude, and the reduced models due to Roychowdhury/Phillips, NORM-sp and NORM-mp led to a runtime speedup of 41×, 118× and 189× over the full model, respectively.

A Double-Balanced Downconversion Mixer

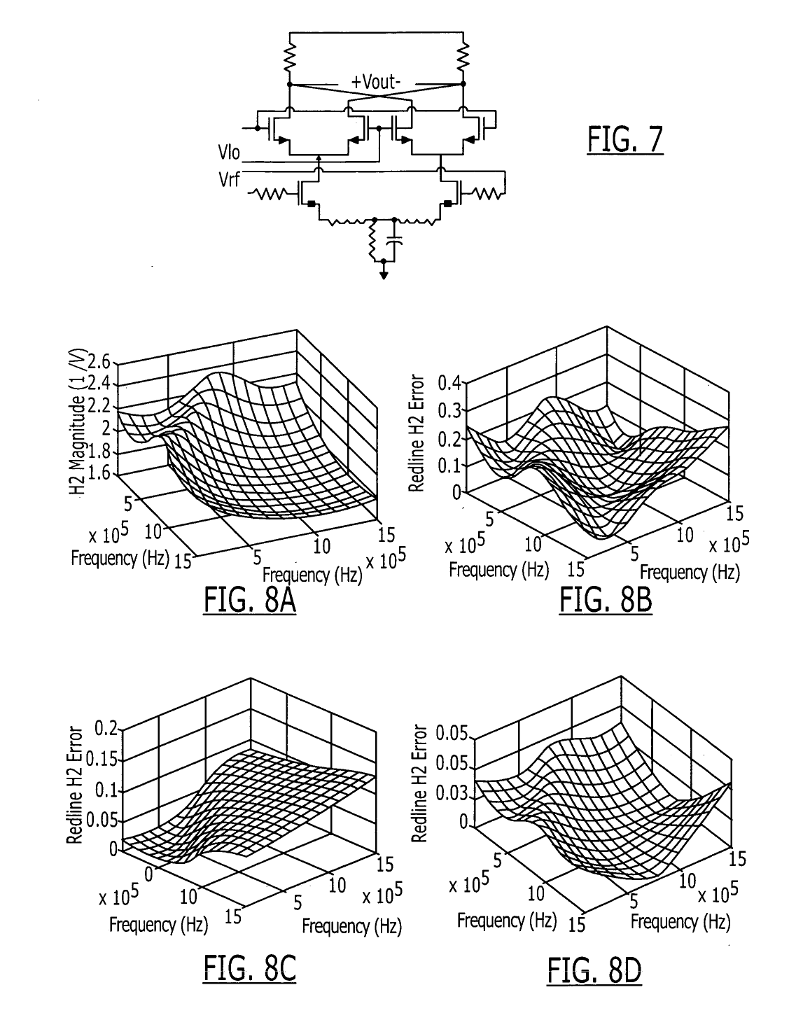

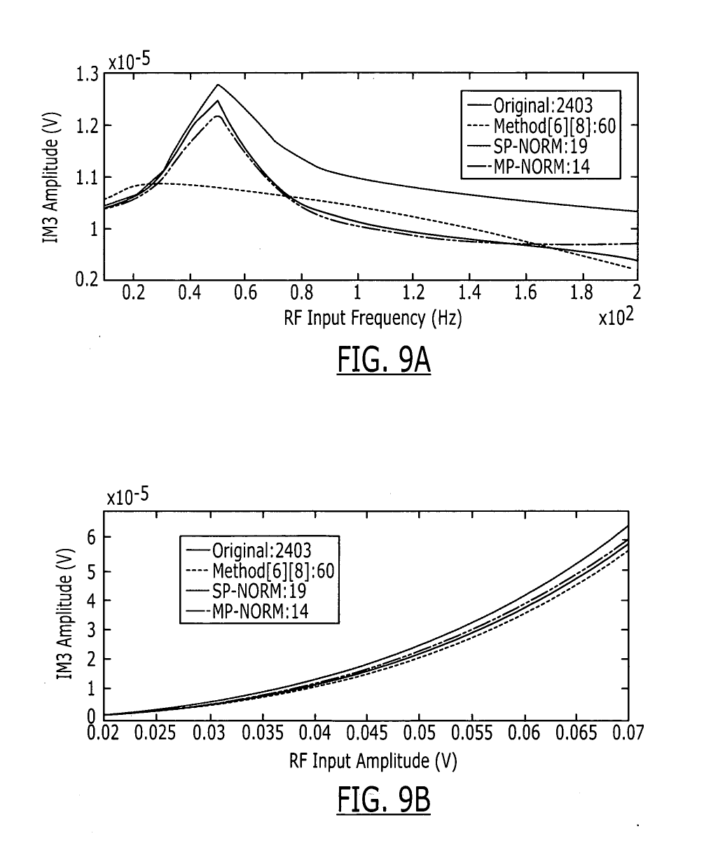

For more realistic examples, next we consider a standard double-balanced mixer shown in FIG. 7, which is modeled as a time varying weakly nonlinear system. Circuit nonlinearities are modeled using third order polynomials around the time-varying operating point due to the large LO. The full model has 2403 time-sampled states and characterized by time-varying Volterra series. The 60 state model generated by the Roychowdhury method matches 4 moments of H₁ and 2 moments of both H₂ and H₃. NORM-sp generates a model with 19 states matching 4 moments for all of H₁, H₂ and H₃. NORM-mp matches 4 matches of H₁ and H₃, 8 moments of H₂ resulting a model size of 14. Because the double-balanced mixer is symmetric, the second order transfer function H₂ is ideally zero (except for numerical noise). To see the third order intermodulation translated by one LO frequency, the corresponding harmonic of the third order time-varying nonlinear transfer function H₃(t,j2πf₁,j2πf₂,j2πf₃) where 100 MHz≦f₁,f₂≦1.5 GHz, f₃=−900 MHz is plotted in FIG. 8A through 8D for the full method, the Roychowdhury/Phillips method, the NORM-sp method, and the NORM-mp method, respectively. The maximum relative errors are 27%, 13% and 4.5% respectively for the Roychowdhury/Phillips method, the NORM-sp method, and the NORM-mp method. These models were also simulated for two-tone third order intermnodulation test using a harmonic-balance simulator as plotted in FIGS. 9A and 9B.

In the first simulation (FIG. 9A), the RF input amplitude was fixed for both tones at 40 mv while varying the frequency of one tone from 100 MHz to 2 GHz (the second tone was separated from the first one by 800 KHz). In the second simulation (FIG. 9B) the two tone frequencies were fixed at 600 MHz and 600.8 MHz, respectively, but the amplitude of the two tones was varied from 20 mv to 70 mv. As can be seen from FIGS. 9A and 9B, the model generated by NORM-mp is the most accurate and also the smallest one for both cases. The 60-state model generated by the Roychowdhury/Phillips method incurs apparent error for the first test. Also note that the amount of IM3 from the simulation is predicted relatively well by the corresponding third order transfer functions.

Due to the relatively large size of resulting third order matrices, the 60-state model of the Roychowdhury/Phillips method brought less than 5× runtime speedup over the full model. However, for the much smaller models produced by NORM-sp and NORM-mp, significant runtime speedups of 350˜380× and 730˜840× were achieved, respectively.

A 2.4 GHz Subharmonic Direct-Conversion Mixer

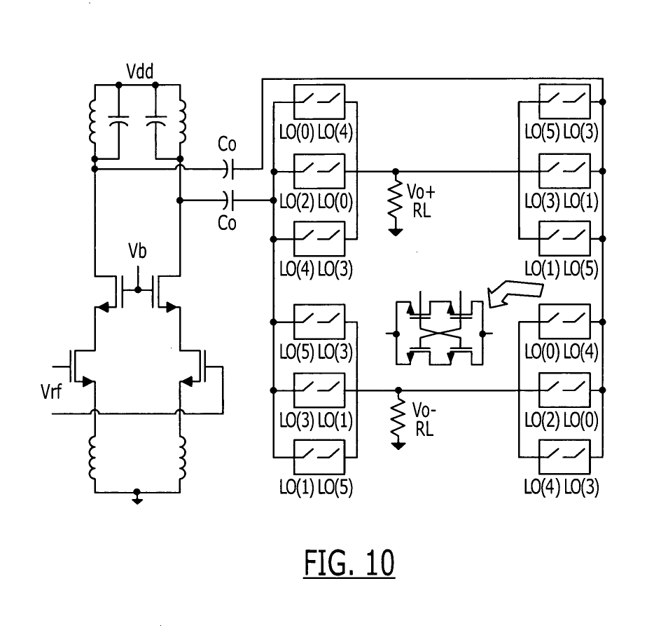

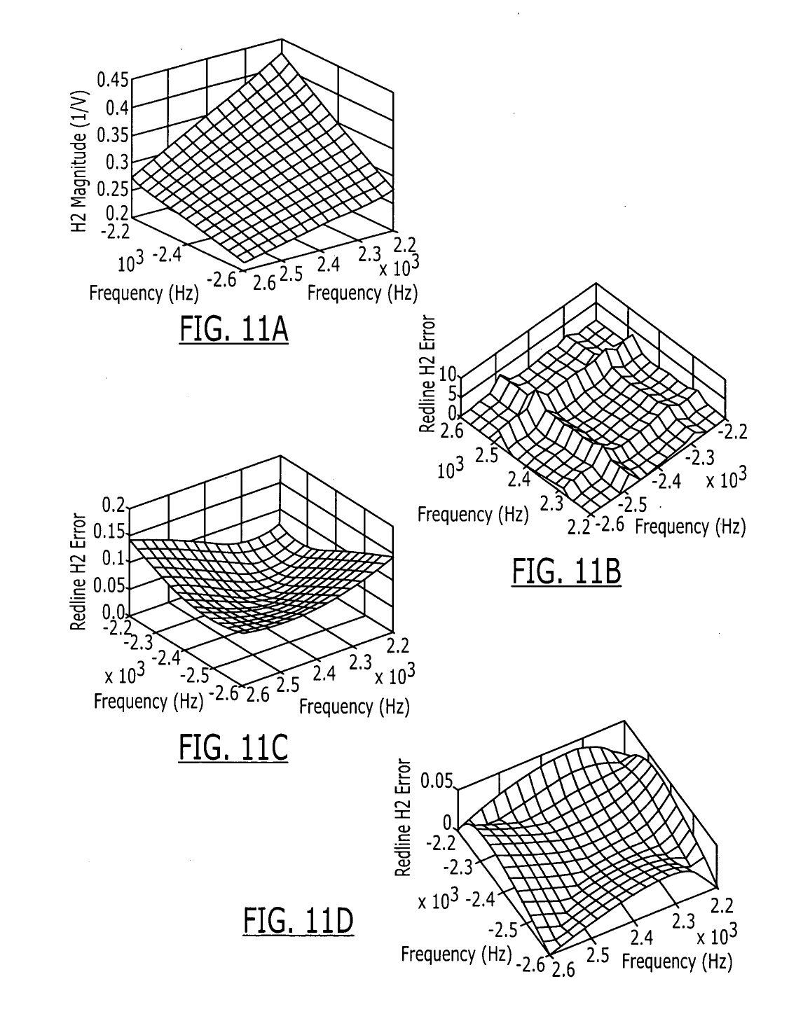

A 2.4 GHz subharmonic direct-conversion mixer used in WCDMA applications is shown in FIG. 10. It uses six phases of a LO signal at 800 MHz to generate an equivalent LO at 2.4 GHz. For direct-conversion mixers, second-order nonlinear effects may be important, which exist when the perfect circuit symmetry is lost in a balanced architecture. For this example, we introduced about 2% transistor width mismatch in the circuit and applied the three methods to reduce the original time-varying system with 4130 time-sampled states, where each circuit nonlinearity is modeled using a time-varying third order polynomial. The zeroth order harmonic of the time-varying H₂ specifying the mixing of two RF tones directly to the baseband is plotted in FIGS. 11A-11D for the full method, the Roychowdhury/Phillips method, the NORM-sp method, and the NORM-mp method, respectively, where two RF frequencies vary from −2.6 GHz to −2.2 GHz, and from 2.2 GHz to 2.6 GH respectively.

The model produced by the Roychowdhury/Phillips method has 122 states and matches 4 moments of H₁, 6 moments of H₂, and 2 moments of H₃. The maximum relative error for this model is about 14%. For both methods, the origin was used as the expansion point. The better accuracy obtained in the smaller model of NORM-sp can be explained by more moments being matched in the reduced model. We anticipate that both methods will generate more accurate models when the correct procedure is used to expand transfer functions at a point close to the center frequency. Lastly, NORM-mp generates a compact 22-state model with the smallest maximum relative error of 4% while matching 6 moments of H₁, 12 moments of H₂, and 4 moments of H₃. In a two-tone harmonic balance simulation, we applied two RF sinusoidal tones around 2.4 GHz with 2 mv amplitude. Explicitly formed reduced models of NORM-sp and NORM-mp provided a runtime speedup of 237× and 1200× over the full model, respectively. Due to the problem of forming the large reduced third order system matrices, however, it may become inefficient to explicitly form the 106-state model of the Roychowdhury/Phillips method. Only the projection matrix was used to reduce the size of the linear problem solved at each simulation iteration. Consequently, the corresponding models did not provide a significant runtime speedup.

Hybrid Approach

Many circuits in RF and analog signal processing applications have sharp frequency selectivity (e.g. containing high-Q filtering). For these cases, as the nonlinear frequency domain system characteristics may vary dramatically within the band of interest, a full projection-based reduction often requires the use of a significant number of projection vectors for achieving sufficient accuracy. As a consequence, forming reduced high-order system matrices can be very expensive due to the large reduced order model size. Therefore, other types of model simplification may be needed. Although numerous nonlinearities can exist in a circuit, there is often a natural tendency for only a few of them to be dominant due to the specific circuit structure. Thus, identifying these dominant nonlinearities within the original circuit structure can be a very useful component of model generation. In the proposed hybrid approach, to cope with circuit problems such as high-Q circuits, the low-order (first and second) responses are matched using projection while high-order (third) response are approximated by exploiting both the circuit internal structure and projection-based model order reduction.

Approximation of Low-Order Responses

For the hybrid approach, we consider the more general scenario of the periodically time-varying weakly nonlinear systems. Instead of using a time-invariant Volterra description, these systems can be characterized by periodically time-varying nonlinear transfer functions Hₙ(t,·). As discussed above, H₁(t,·) can be discretized using back-Euler based techniques on M sample points \overline{H}ₙ=[Hₙ(t₁,·)^{T},Hₙ(t₂,·)^{T} . . . , Hₙ(t_{M},·)^{T}]^{T} within a period of the system time variation T. A set of matrices \overline{G}₁,\overline{C}₁,\overline{b}₁,\overline{G}₂,\overline{C}₂,\overline{G}₃,\overline{C}₃, can be formulated based on the discretization of the system nonlinear characteristics over a period T for periodically time-varying systems. Using these matrices, Equations 17 through 19 can be reformulated in terms of \overline{H}₁,\overline{H}₂,\overline{H}₃. Each of these equations now has M×N unknowns and can be reduced directly using NORM, where N is the number of physical circuit unknowns of the system.

Assume that M=2K−1, where K is an integer, and consider the application of the NORM methodology to approximate the first and second nonlinear transfer functions. The corresponding projection matrix is denoted as V ε R^{NM×q}, where q is the size of the reduced order model. The first and second order matrices generated by NORM are written as Equation (43) below:

$$\begin{matrix}{\tilde{G}}_{1} = {V}^{T} \vec{{G}_{1}} V ∈ {R}^{qxq} , {\tilde{C}}_{1} = {V}^{T} \overline{{C}_{1}} V ∈ {R}^{qxq} , {\tilde{b}}_{1} = {V}^{T} \overline{b} ∈ {R}^{qx1} \\ {\tilde{G}}_{2} = {V}^{T} \overline{{G}_{2}} ( V ⊗ V ) ∈ {R}^{{qxq}^{2}} , {\tilde{C}}_{2} = {V}^{T} \overline{{C}_{2}} ( V ⊗ V ) ∈ {R}^{{qxq}^{2}}\end{matrix} \qquad ( 43 )$$

Substituting Equation (43) into Equations (17) and (18), the first and second order transfer functions \tilde{H}₁ and \tilde{H}₂ of the reduced model may be determined. The time sampled first and second order transfer functions of the original system can be approximated as set forth in Equation (44) below:

$${\overline{H}}_{1} = V {\tilde{H}}_{1} , {\overline{H}}_{2} = V {\tilde{H}}_{2} \qquad ( 44 )$$

As the reduced model of Equations (43) and (44) represents a time-invariant system, the approximation of the first and second order responses of the original periodically time-varying system involves the use of the discrete Fourier transform. It can be shown that the following qth order system is a time-domain realization of the corresponding reduced model:

$$\{ \begin{matrix}\frac{ⅆ}{ⅆ t} ( {\tilde{C}}_{1} {\tilde{x}}_{1} ) + {\tilde{G}}_{1} {\tilde{x}}_{1} = \tilde{b} {u}_{s} ( t ) \\ \frac{ⅆ}{ⅆ t} ( {\tilde{C}}_{1} {\tilde{x}}_{2} ) + {\tilde{G}}_{1} {\tilde{x}}_{2} = \frac{ⅆ}{ⅆ t} ( {\tilde{C}}_{2} ( {\tilde{x}}_{1} ⊗ {\tilde{x}}_{1} ) ) - {\tilde{G}}_{2} ( {\tilde{x}}_{1} ⊗ {\tilde{x}}_{1} ) \\ \tilde{y} ( t ) = [ \begin{matrix}{\tilde{y}}_{1} \\ {\tilde{y}}_{2}\end{matrix} ] = [ \begin{matrix}J0 \\ 0 J\end{matrix} ] [ \begin{matrix}{\tilde{x}}_{1} \\ {\tilde{x}}_{2}\end{matrix} ]\end{matrix} \qquad ( 45 )$$

where J=D·Γ·V·V,Γ is the DFT matrix converting M time samples to the corresponding Fourier coefficients, D=[e^{-jk}^{ₒ}¹I_{N×N}, . . . I_{N×N}, . . . ,e^{jk}^{ₒ}¹I_{N×N}],I_{N×N} is the N×N identify matrix. The first and second order responses of the original system can be approximated in the time domain by \hat{x}₁=\tilde{y}₁,\hat{x}₂=\tilde{y}₂.

Approximation of the Third Order Response

In a full projection based approach, nonlinear model order reduction can be limited by the difficulty in explicitly forming the projected (dense) third order system matrices, especially for relatively large model sizes. Pruning based model simplification can be instead performed in the original system coordinates. Thus, the sparsity of the original circuit problem is not lost, but further enhanced. To approximate the third order transfer function based on the reduced model of Equations (43) through (45), Equation (43) maybe substituted into Equation (19) resulting in Equation (46):

$$[ {\overline{G}}_{1} + \tilde{s} \overline{C} ] {\overline{H}}_{3} ( {s}_{1} , {s}_{2} , {s}_{3} ) = g , \qquad ( 46 )$$

where

$$\begin{matrix}g = [ {\overline{G}}_{3} + \tilde{s} {\overline{C}}_{3} ] \cdot {u}_{1} + [ {\overline{G}}_{2} + \tilde{s} {\overline{C}}_{2} ] \cdot {u}_{2} \\ {u}_{1} = - \overline{( ( V {\tilde{H}}_{1} ( {s}_{1} ) ) ⊗ ( V {\tilde{H}}_{1} ( {s}_{2} ) ) ⊗ ( V {\tilde{H}}_{1} ( {s}_{3} ) )} \\ {u}_{2} = - 2 \overline{( V {\tilde{H}}_{1} ( {s}_{1} ) ) ⊗ ( V {\tilde{H}}_{2} ( {s}_{2} , {s}_{3} ) )}\end{matrix} \qquad ( 47 )$$

Based on the Equations above, to compute the third order transfer function, one needs to solve a linear system in terms of \overline{G}₁ and \overline{C}₁, and form the input to the linear system in terms of g that is a function of high-order system matrices \overline{G}₂,\overline{C}₂,\overline{G}₃,\overline{C}₃, and low order transfer functions \overline{H}₁,\overline{H}₂. As \overline{H}₁,\overline{H}₂, are approximated using Equation (44), to further reduce Equation (46) involves reduction of the dimension of the linear problem in Equation (46) as well as the high-order system matrices \overline{G}₂,\overline{C}₂,\overline{G}₃,\overline{C}₃. This goal is accomplished by a combination of projection-based reduction of an adjoint network and direct matrix pruning.

In analog signal processing and RF applications, a circuit block usually has only one or at most a few output nodes. For periodically time-varying systems, typically only a small number of sidebands for the outputs are of interest. Thus, Equation (46) may be viewed as a system with potentially many inputs but few outputs, and can be reduced as an adjoint network. Without loss of generality, assume only the ith sideband of the voltage response at node p is of interest (e.g., i=0 pus or minus 1). Define l=[00 . . . 1 . . . 0]^{T} as a N×1 vector that has a 1 at the pth location and zeros at all other locations, and
L=diag(l^{T},l^{T}, . . . l^{T}) ε R^{M×NM}
d=[1e^{-j2πi/M} . . . e^{-j2π(M-1)i/M}]^{T}/M, bₐ=L^{T}d (48)
The ith sideband of the third order transfer function at node p, yₚ_{ᵢ}, (corresponding to the ith harmonic of the third order transfer function for node p) can be obtained from the adjoint network

$$[ {\overline{G}}_{1}^{T} + \tilde{s} {\overline{C}}_{1}^{T} ] z ( {s}_{1} , {s}_{2} , {s}_{3} ) = {b}_{a} \\ {y}_{pi} = {g}^{T} z \qquad ( 49 )$$

We can apply Krylov subspace projection to reduce the linear adjoint network of Equation (49)

$${\hat{G}}_{a} = {V}_{a}^{T} {\overline{{G}_{1}}}^{T} {V}_{a} , {\hat{C}}_{a} = {V}_{a}^{T} {\overline{{C}_{1}}}^{T} {V}_{a} , {\hat{b}}_{a} = {V}_{a}^{T} {b}_{a} , \qquad ( 50 )$$

where Vₐ is a orthonormal basis of the Krylov subspace colspan{rₐ,Aₐrₐ,A²ₐrₐ . . .} with Aₐ=−\overline{G}₁^{-T}\overline{C}₁^{T},rₐ=\overline{G}₁^{-T}bₐ. As the DFT vector d is absorbed into bₐ, to perform a real projection, bₐ can be split into real and imaginary parts before reduction. Based on Equations (49) and (50), yₚ_{ᵢ} can be approximated as

$${y}_{pi} = {g}^{T} \hat{z} , \hat{z} = {{V}_{a} [ {\hat{G}}_{a} + \tilde{s} {\hat{C}}_{a} ]}^{- 1} {\hat{b}}_{a} \qquad ( 51 )$$

To speed up the computation of the third order transfer function or response, high order system matrices \overline{G}₂,\overline{C}₂,\overline{G}₃,\overline{C}₃ need to be reduced. To avoid forming dense reduced matrices (particularly for the third order ones) in a projection based approach, the internal structure of the problem may be exploited by applying a direct matrix pruning technique, where nonzero elements of \overline{G}₂,\overline{C}₂,\overline{G}₃,\overline{C}₃ are pruned according to their contributions to the third order transfer function at the output node of interest. Although a nonlinear circuit may contain many nonlinearities, a few of them tend to be dominant. Therefore, retaining the original circuit structural information by avoiding using projection and applying pruning to these high-order matrices in the original coordinates can be effective for model generation.

The matrix pruning process may be performed as follows in accordance with some embodiments of the present invention: A set of sampled frequency points Ω are selected within the frequency band of interest. For each of these frequency samples, the third order transfer function is computed as well as the individual contributions of nonzeros in \overline{G}₂,\overline{C}₂,\overline{G}₃,\overline{C}₃. These contributions are sorted by magnitude and non-dominant ones are discarded provided that a user specified error tolerance on H₃ is not exceeded. A matrix entry is discarded if and only if its removal does not violate the model accuracy at all the frequency points. The end products of the process are a set of pruned matrices \overline{G}₂ₚ,\overline{C}₂ₚ,\overline{G}₃ₚ,\overline{C}₃ₚ that satisfy the error tolerance for all the sampled frequency points in Ω. These pruned high order system matrices retain the same dimensions as in the original system while their sparsity can be improved as a result of pruning. As the computation of H₃ and individual contributions may take place on many sample points, matrix pruning may be relatively slow. To speed up the process, projection based model reduction may be incorporated into the pruning process.

To compute H₃ at a frequency point H₁ and H₂ need to be computed at related points. According to Equation (47), to form vector g, the reduced order model of Equations (43) and (44) may be used to compute approximate first and second order transfer functions. Then, instead of solving a potentially large linear problem in Equation (46), the reduced adjoint network of Equation (51) can be used to approximate \hat{z}. Computation of each individual contribution term is based on Equations (47) and (51). For example, the contribution of the nonzero at the (m,n) location of \overline{G}₃ can be computed as follows:

$${δ}_{g3 , m , n} = \overline{{G}_{3 , m , n}} \cdot {u}_{1 , n} \cdot {\hat{z}}_{m} , \qquad ( 52 )$$

where \overline{G}_{3,m,n} is the value of the nonzero, u_{1,n} is the nth element of u₁, and \hat{z}ₘ is the mth element of \hat{z}. Because reduced order models are used, factorizing the original large system matrices at many sample points may be avoided. The cost for constructing projection-based reduced order models according to Equations (43) and (51) is generally dominated by the cost of a few matrix factorizations and is therefore bounded by o(kM³N³), where k is the number of matrix factorizations, M is the number of sampled points used to discretize the periodically time-varying transfer functions, and N is the number of physical circuit unknowns. The cost of the pruning process is dominated by evaluation and sorting of the different combinations, assuming that the use of reduced order models makes other costs generally less. The overall cost for model generation is, therefore, bounded by o(sE log(E)+kM³N³), where s is the number of frequency samples evaluated in the pruning, and E is the number of nonzeros in the high order matrices being pruned.

Using the pruned matrices \overline{G}₂ₚ,\overline{C}₂ₚ,\overline{G}₃ₚ,\overline{C}₃ₚ, Equation (47) can be further approximated as follows:

$$\begin{matrix}\hat{g} = - [ {\overline{G}}_{3 p} + \tilde{s} {\overline{C}}_{3 p} ] \cdot \overline{( V {\tilde{H}}_{1} ( {s}_{1} ) ) ⊗ ( V {\tilde{H}}_{1} ( {s}_{2} ) ) ⊗ ( V {\tilde{H}}_{1} ( {s}_{3} )} - \\ 2 [ {\overline{G}}_{2 p} + \tilde{s} {\overline{C}}_{2 p} ] \cdot \overline{( V {\tilde{H}}_{1} ( {s}_{1} ) ) ⊗ ( V {\tilde{H}}_{2} ( {s}_{2} , {s}_{3} ) )}\end{matrix} \qquad ( 53 )$$

To derive a time-domain model for generating the desired third order response, Equation (53) is substituted into Equation (51) and both sides of the equation are transposed as follows:

$${y}_{pi} = {{\hat{b}}_{a}^{T} [ {\hat{G}}_{a}^{T} + \tilde{s} {\hat{C}}_{a}^{T} ]}^{- 1} {V}_{a}^{T} \hat{g} \qquad ( 54 )$$

Defining

$$\overline{{X}_{111}} = V {\tilde{x}}_{1} ⊗ V {\tilde{x}}_{1} ⊗ V {\tilde{x}}_{1} , \overline{{x}_{12}} = \frac{1}{2} ( V {\tilde{x}}_{1} ⊗ V {\tilde{x}}_{2} + V {\tilde{x}}_{2} ⊗ V {\tilde{x}}_{1} ) , \qquad ( 55 )$$

it may be shown that the corresponding time domain model is

$$\{ \begin{matrix}\frac{ⅆ}{ⅆ t} ( {\hat{C}}_{a}^{T} {x}_{a} ) + {\hat{G}}_{n}^{T} {x}_{a} = \\ - {V}_{a}^{T} ( \overline{{G}_{3 p}} \cdot \overline{{x}_{111}} + \frac{ⅆ}{ⅆ t} ( \overline{{C}_{3 p}} \cdot \overline{{x}_{111}} ) + 2 \overline{{G}_{2 p}} \cdot \overline{{x}_{12}} + \frac{ⅆ}{ⅆ t} ( \overline{{C}_{2 p}} \cdot \overline{{x}_{12}} ) ) \\ \hat{{y}_{p , 3}} ( t ) = {ⅇ}^{j ⅈ ω 0 t} {b}_{a}^{T} {x}_{a}\end{matrix} \qquad ( 56 )$$

where \grave{x}₁,\grave{x}₂ are given in Equation (45), \grave{y}_{p,3}(t) is the desired time-domain third order response. Because the ith harmonics of the third order transfer functions are considered the output, \grave{y}_{p,3}(t) in the above equation is complex. To recover the corresponding real signal, the corresponding conjugate component may be added. The first and second order responses at node p, \grave{y}_{p,1}(t), and e,gra y_{p,2}(t) can be obtained from Equation (45) by selecting proper entries from \grave{y}. When more than one output or set of sidebands are of interest, multiple reduced adjoint networks can be incorporated into the model in a straightforward way.
Hybrid Model Results

Switched-capacitor filters are often found in RF receivers as channel-select filters. If the input signal is small, then these circuits can be characterized by periodically time-varying Volterra series. Due to the typical sharp transition between the passband and stopband, it can be very difficult to apply a full-projection based model reduction.

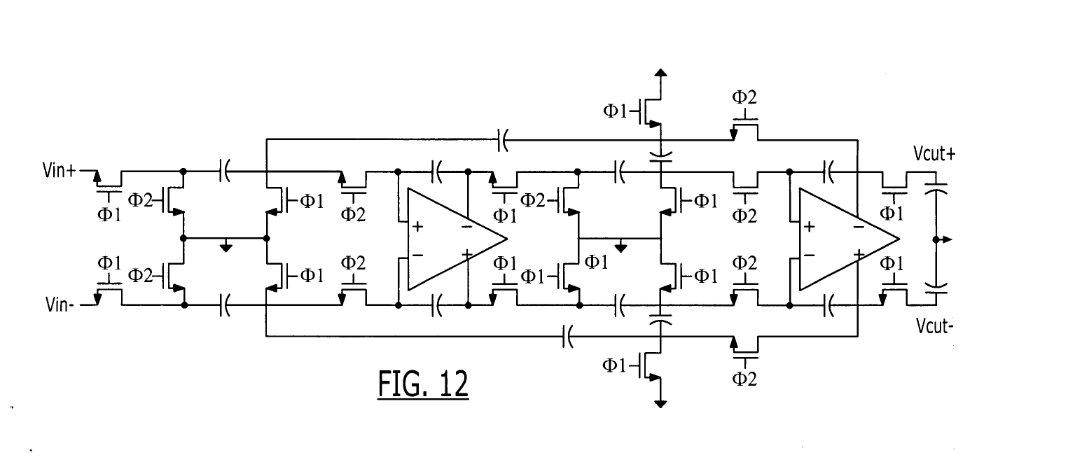

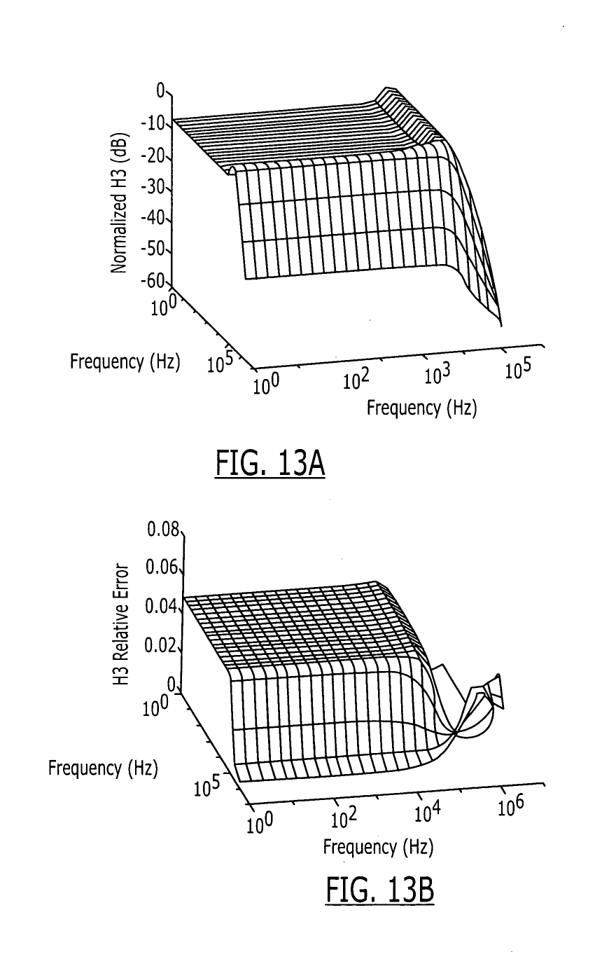

To demonstrate the proposed hybrid approach, consider a Butterworth lowpass switched-capacitor biquad shown in FIG. 12. The two-phase clock is at 20 MHz, and the 3-dB frequency of the filter is about 700 kHz. Each circuit nonlinearity in the filter is modeled as a third order polynomial about the periodically varying operating point generated by the clock. The resulting full model has 8142 time-sampled circuit unknowns. To view the third order nonlinear effects within and close to the signal band, the DC component of the periodically time-varying third order nonlinear transfer function H₃(t,j2πf₁,j2πf₂,j2πf₃), where 1 Hz≦f₁, f₂≦10 MHz, f₃=−1 Hz, is plotted in FIG. 13A. It is clearly observable that the third order nonlinear characteristics vary dramatically between passband and stopband. To capture not only the nonlinear distortions due to the signals within the passband, but also the third order mixing of the large out of channel interferers into the passband, the nonlinear frequency-domain characteristics of the filter may be modeled accurately over a frequency range of 7 decades. As such, a complete projection based approach may become inefficient because a sufficient number of moments may need to be matched for accuracy, while the resulting model size leads to expensive dense projected third order matrices.

To apply the hybrid approach, we first used the multi-point NORM algorithm to accurately capture the first and second transfer functions using a reduced order model with 27 states (SVD was used to deflate the Krylov subspaces), where 6 moments of H₁ and 24 moments of H₂ were matched. The adjoint network describing propagation of the third order nonlinear effects from various nonlinearities to the output was reduced to an 11th order model. Based on these reduced models, \overline{G}₂,\overline{C}₂,\overline{G}₃,\overline{C}₃ were significantly pruned in the original coordinates at 225 frequency points. Running on an IBM RS6000 workstation, it took 342 CPU seconds to complete the model generation. The overall runtime was dominated by the time spent in pruning. Therefore, the trade-off between runtime and accuracy can be made by selecting an appropriate number of frequency points used for pruning. The original second and third order system matrices have 45,221 and 84,521 nonzeros while the pruned matrices have only 196 and 430 nonzeros, respectively. The final hybrid model has a maximum relative modeling error less than 6% (or about 0.5 dB) for H₃ as shown in FIG. 13B.

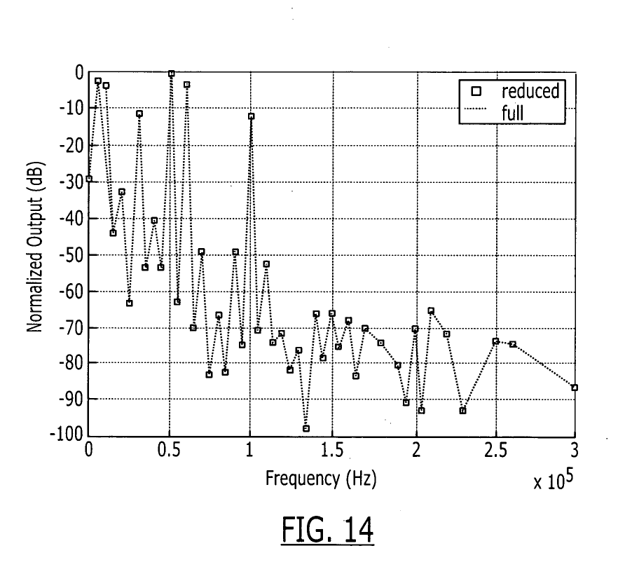

This hybrid model was also validated in a frequency-domain Volterra-like simulation using MATLAB, where 6 sinusoidals with various phases were selected from passband, transition band and stopband as input signals. The simulation result was compared against that of the full model, as shown in FIG. 14. As shown in FIG. 14, the hybrid model captures the frequency-domain nonlinear characteristics of the filter over a wide range of input band relatively accurately. It took approximately 1400 seconds to simulate the full mode, while the runtime of the reduced model was only about 23 seconds. In this example, only a small number input frequencies were considered in the frequency-domain Volterra-like simulation. With respect to the model generation time, the saving in simulation time would typically be more significant for time-domain simulations and larger frequency-domain simulations where many input frequencies are included.

Conclusion

The rapid growth of reduced order models for nonlinear time-varying systems, may make model order reduction more difficult than for the case of linear time invariant system order reduction. The new challenge originates because information about more complex nonlinear system effects may be encapsulated in the reduced order model in addition to the first order system properties. The proposed nonlinear system order reduction methodology, NORM, that is based on using a set of minimum Krylov subspaces for moment matching of nonlinear transfer functions, can produce relatively compact macromodels.

Thus, given that modeling of nonlinear systems may result in relatively large models that may be difficult to use and/or require extensive computational resources, some embodiments of the invention can provide more compact reduced order models for nonlinear systems. Some embodiments of the invention begin with a general matrix-form nonlinear transfer functions needed for model order reduction and derive the expressions for nonlinear transfer function moments. This development leads to a deeper understanding on the interaction between Krylov subspace projection and the moment matching under nonlinear context. From this development, embodiments of the invention can provide a new reduction scheme, NORM, which may reduce the size of reduced order models and copes with the model growth problem for nonlinear system representation by using a set of minimum Krylov subspaces.

Some embodiments of the invention can provide features for controlling the growth of reduced order models. First, the modeling accuracy for the nonlinear effect at each order can be selected individually for application-specific needs, while the overall reduced nonlinear model is constructed based on the interactions of moment matching for nonlinear transfer functions of different orders. This may allow the introduction of useless projection vectors for moment matching to be avoided. Second, to target the nonlinear system behavior within the circuit-specific frequency band of interest, the procedure for moment-matching with complex expansion points is accommodated. This may be particularly useful for certain narrow-band RF systems for which it may be beneficial to expand along an imaginary axis about the center frequency. Different from the reduction of an LTI system, however, it can be shown that moment matching of nonlinear transfer functions at a single frequency expansion point inherits multiple matrix factorizations. Therefore, by trading off computational cost with model compactness, some embodiments of the invention can provide a multi-point version of the NORM algorithm that further reduces the total dimension of the Krylov subspaces used in the projection, thereby producing a more compact model.

In concluding the detailed description, it should be noted that many variations and modifications can be made to the preferred embodiments without substantially departing from the principles of the present invention. All such variations and modifications are intended to be included herein within the scope of the present invention, as set forth in the following claims. The following claim is provided to ensure that the present application meets all statutory requirements as a priority application in all jurisdictions and shall not be construed as setting forth the scope of the present invention.

1. A method of modeling a nonlinear system, comprising:
obtaining a transfer function for the nonlinear system;
generating a Taylor series expansion of the transfer function, the Taylor series expansion comprising a plurality of moments respectively corresponding to a plurality of coefficients of the Taylor series terms;
deriving at least one Krylov subspace that matches at least one of the plurality of moments; and
modeling the nonlinear system using the at least one Krylov subspace.

2. The method of claim 1, wherein deriving the at least one Krylov subspace comprises:
selecting an order k of the plurality of moments to be matched; and
deriving at least one Krylov subspace that matches at least one of the kth order moments of the plurality of moments.

3. The method of claim 2, further comprising:
selecting a plurality of sample points;
generating the k+1th order Transfer function at each of the plurality of sample points;
determining contributions of non-linear elements in the k+1th order Transfer function generated at each of the plurality of sample points;
discarding selected non-linear elements from the k+1th order Transfer function generated at each of the plurality of sample points to obtain a pruned system that approximates k+1th order Transfer function; and
wherein modeling the nonlinear system comprises:
modeling the nonlinear system using the at least one Krylov subspace and the pruned system that approximates k+1th order Transfer function.

4. The method of claim 2, wherein generating the Taylor series expansion comprises:
generating a plurality of Taylor series expansions of the Transfer function about a plurality of expansion points, each of the plurality of Taylor series expansions comprising a plurality of moments; and
wherein deriving the at least one Krylov subspace comprises:
selecting an order k of the plurality of moments to be matched based on a number of the plurality of expansion points; and
deriving at least one Krylov subspace that matches at least one of the kth order moments of respective ones of the plurality of moments for the plurality of expansion points.

5. The method of claim 1, wherein generating the Taylor series expansion comprises:
generating a plurality of Taylor series expansions of the Transfer function about a plurality of expansion points, each of the plurality of Taylor series expansions comprising a plurality of moments; and
wherein deriving the at least one Krylov subspace comprises:
deriving at least one Krylov subspace that matches at least one of the plurality of moments for the plurality of expansion points.

6. The method of claim 1, wherein the transfer function comprises a single variable transfer function component and a multi-variable transfer function component.

7. The method of claim 1, wherein respective ones of the plurality of moments are matrices.

8. A method for modeling a nonlinear system, comprising:
obtaining a transfer function for the nonlinear system;
generating a plurality of Taylor series expansions of the Transfer function about a plurality of expansion points, each of the plurality of Taylor series expansions comprising a plurality of moments respectively corresponding to a plurality of coefficients of the Taylor series terms;
selecting an order k of the plurality of moments to be matched based on a number of the plurality of expansion points;
deriving at least one Krylov subspace that matches at least one of the kth order moments of respective ones of the plurality of moments for the plurality of expansion points; and
modeling the nonlinear system using the at least one Krylov subspace.

9. A system for modeling a nonlinear system, comprising:
means for obtaining a transfer function for the nonlinear system;
means for generating a Taylor series expansion of the transfer function, the Taylor series expansion comprising a plurality of moments respectively corresponding to a plurality of coefficients of the Taylor series terms;
means for deriving at least one Krylov subspace that matches at least one of the plurality of moments; and
means for modeling the nonlinear system using the at least one Krylov subspace.

10. The system of claim 9, wherein the means for deriving the at least one Krylov subspace comprises:
means for selecting an order k of the plurality of moments to be matched; and
means for deriving at least one Krylov subspace that matches at least one of the kth order moments of the plurality of moments.

11. The system of claim 10, further comprising:
means for selecting a plurality of sample points;
means for generating the k+1th order Transfer function at each of the plurality of sample points;
means for determining contributions of non-linear elements in the k+1th order Transfer function generated at each of the plurality of sample points;
means for discarding selected non-linear elements from the k+1th order Transfer function generated at each of the plurality of sample points to obtain a pruned system that approximates k+1th order Transfer function; and
wherein the means for modeling the nonlinear system comprises:
means for modeling the nonlinear system using the at least one Krylov subspace and the pruned system that approximates the k+1th order Transfer function.

12. The system of claim 10, wherein the means for generating the Taylor series expansion comprises:
means for generating a plurality of Taylor series expansions of the Transfer function about a plurality of expansion points, each of the plurality of Taylor series expansions comprising a plurality of moments; and
wherein the means for deriving the at least one Krylov subspace comprises:
means for selecting an order k of the plurality of moments to be matched based on a number of the plurality of expansion points; and
means for deriving at least one Krylov subspace that matches at least one of the kth order moments of respective ones of the plurality of moments for the plurality of expansion points.

13. The system of claim 9, wherein the means for generating the Taylor series expansion comprises:
means for generating a plurality of Taylor series expansions of the Transfer function about a plurality of expansion points, each of the plurality of Taylor series expansions comprising a plurality of moments; and
wherein the means for deriving the at least one Krylov subspace comprises:
means for deriving at least one Krylov subspace that matches at least one of the plurality of moments for the plurality of expansion points.

14. The system of claim 9, wherein the transfer function comprises a single variable transfer function component and a multi-variable transfer function component.

15. The system of claim 9, wherein respective ones of the plurality of moments are matrices.

16. A system for modeling a nonlinear system, comprising:
means for obtaining a transfer function for the nonlinear system;
means for generating a plurality of Taylor series expansions of the Transfer function about a plurality of expansion points, each of the plurality of Taylor series expansions comprising a plurality of moments respectively corresponding to a plurality of coefficients of the Taylor series terms;
means for selecting an order k of the plurality of moments to be matched based on a number of the plurality of expansion points;
means for deriving at least one Krylov subspace that matches at least one of the kth order moments of respective ones of the plurality of moments for the plurality of expansion points; and
means for modeling the nonlinear system using the at least one Krylov subspace.

17. A computer program product for modeling a nonlinear system, comprising:
a computer readable storage medium having computer readable program code embodied therein, the computer readable program code comprising:
computer readable program code configured to obtain a transfer function for the nonlinear system;
computer readable program code configured to generate a Taylor series expansion of the transfer function, the Taylor series expansion comprising a plurality of moments respectively corresponding to a plurality of coefficients of the Taylor series terms;
computer readable program code configured to derive at least one Krylov subspace that matches at least one of the plurality of moments; and
computer readable program code configured to model the nonlinear system using the at least one Krylov subspace.

18. The computer program product of claim 17, wherein the computer readable program code configured to derive the at least one Krylov subspace comprises:
computer readable program code configured to select an order k of the plurality of moments to be matched; and
computer readable program code configured to derive at least one Krylov subspace that matches at least one of the kth order moments of the plurality of moments.

19. The computer program product of claim 18, further comprising:
computer readable program code configured to select a plurality of sample points;
computer readable program code configured to generate the k+1th order Transfer function at each of the plurality of sample points;
computer readable program code configured to determine contributions of non-linear elements in the k+1th order Transfer function generated at each of the plurality of sample points;
computer readable program code configured to discard selected non-linear elements from the k+1th order Transfer function generated at each of the plurality of sample points to obtain a pruned system that approximates the k+1th order Transfer function; and
wherein the computer readable program code configured to model the nonlinear system comprises:
computer readable program code configured to model the nonlinear system using the at least one Krylov subspace and the pruned system that approximates the k+1th order Transfer function.

20. The computer program product of claim 18, wherein the computer readable program code configured to generate the Taylor series expansion comprises:
computer readable program code configured to generate a plurality of Taylor series expansions of the Transfer function about a plurality of expansion points, each of the plurality of Taylor series expansions comprising a plurality of moments; and
wherein the computer readable program code configured to derive the at least one Krylov subspace comprises:
computer readable program code configured to select an order k of the plurality of moments to be matched based on a number of the plurality of expansion points; and
computer readable program code configured to derive at least one Krylov subspace that matches at least one of the kth order moments of respective ones of the plurality of moments for the plurality of expansion points.

21. The computer program product of claim 17, wherein the computer readable program code configured to generate the Taylor series expansion comprises:
computer readable program code configured to generate a plurality of Taylor series expansions of the Transfer function about a plurality of expansion points, each of the plurality of Taylor series expansions comprising a plurality of moments; and
wherein the computer readable program code configured to derive the at least one Krylov subspace comprises:
computer readable program code configured to derive at least one Krylov subspace that matches at least one of the plurality of moments for the plurality of expansion points.

22. The computer program product of claim 17, wherein the transfer function comprises a single variable transfer function component and a multi-variable transfer function component.

23. The computer program product of claim 17, wherein respective ones of the plurality of moments are matrices.

24. A computer program product for modeling a nonlinear system, comprising:
a computer readable storage medium having computer readable program code embodied therein, the computer readable program code comprising:
computer readable program code configured to obtain a transfer function for the nonlinear system;
computer readable program code configured to generate a plurality of Taylor series expansions of the Transfer function about a plurality of expansion points, each of the plurality of Taylor series expansions comprising a plurality of moments respectively corresponding to a plurality of coefficients of the Taylor series terms;
computer readable program code configured to select an order k of the plurality of moments to be matched based on a number of the plurality of expansion points;
computer readable program code configured to derive at least one Krylov subspace that matches at least one of the kth order moments of respective ones of the plurality of moments for the plurality of expansion points; and
computer readable program code configured to model the nonlinear system using the at least one Krylov subspace.
